(19) United States
(12) Patent Application Publication
(10) Pub. No.: US 2022/0342894 A1
(43) Pub. Date: Oct. 27, 2022

(54) COMPUTER-READABLE RECORDING MEDIUM STORING INFORMATION PROCESSING PROGRAM, INFORMATION PROCESSING METHOD, AND INFORMATION PROCESSING DEVICE

(71) Applicant: FUJITSU LIMITED, Kawasaki-shi (JP)

(72) Inventors: Mari YAMAOKA, Minato (JP); Shingo OKUNO, Kawasaki (JP)

(73) Assignee: FUJITSU LIMITED, Kawasaki-shi (JP)

(21) Appl. No.: 17/585,632

(22) Filed: Jan. 27, 2022

(30) Foreign Application Priority Data
Apr. 23, 2021 (JP) 2021-073621

(51) Int. Cl. G06F 16/25; G06K 9/62

(52) U.S. Cl. CPC G06F 16/252; G06K 9/623; G06K 9/6231

(57) ABSTRACT

A non-transitory computer-readable recording medium stores an information processing program for causing a computer to execute processing including: at each predetermined time point, measuring a first type of a feature value regarding the corresponding time point; calculating an accumulated difference value from a first feature value regarding a first time point to a second feature value regarding a second time point after the first time point, among the measured feature values; and determining whether or not the second feature value is set as a transfer target to be transferred to a storage destination on the basis of a result of comparing the calculated accumulated difference value with a threshold.

### CROSS-REFERENCE TO RELATED APPLICATION

This application is based upon and claims the benefit of priority of the prior Japanese Patent Application No. 2021-73621, filed on Apr. 23, 2021, the entire contents of which are incorporated herein by reference.

### FIELD

The embodiment discussed herein is related to an information processing program, an information processing method, and an information processing device.

### BACKGROUND

Typically, there has been a system in which a data collection device measures some feature values, temporarily stores the measured feature value in a buffer, and transmits the stored feature value to a data management device, and makes a database (DB) included in the data management device store the transmitted feature value. The feature value is, for example, a value indicating a usage status of a resource of a central processing unit (CPU), a memory, or the like. Here, it is expected that a temporal change in a feature value can be accurately specified if a measurement frequency of the data collection device is improved.

International Publication Pamphlet No. WO 2018/220813, Japanese Laid-open Patent Publication No. 2010-078467, and Japanese Laid-open Patent Publication No. 2015-176245 are disclosed as related art.

### SUMMARY

According to an aspect of the embodiments, a non-transitory computer-readable recording medium stores an information processing program for causing a computer to execute processing including: at each predetermined time point, measuring a first type of a feature value regarding the corresponding time point; calculating an accumulated difference value from a first feature value regarding a first time point to a second feature value regarding a second time point after the first time point, among the measured feature values; and determining whether or not the second feature value is set as a transfer target to be transferred to a storage destination on the basis of a result of comparing the calculated accumulated difference value with a threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing method according to an embodiment;

FIG. 2 is an explanatory diagram illustrating an example of an information processing system 200;

FIG. 3 is a block diagram illustrating a hardware configuration example of an information processing device 100;

FIG. 4 is an explanatory diagram illustrating an example of storage content of a buffer 400;

FIG. 5 is a block diagram illustrating a hardware configuration example of an information management device 201;

FIG. 6 is a block diagram illustrating a functional configuration example of the information processing device 100;

FIG. 7 is a block diagram illustrating a specific functional configuration example of the information processing system 200;

FIG. 8 is an explanatory diagram illustrating a flow of an operation of the information processing device 100;

FIG. 9 is an explanatory diagram (part 1) illustrating an example of the operation of the information processing device 100;

FIG. 10 is an explanatory diagram (part 2) illustrating an example of the operation of the information processing device 100;

FIG. 11 is an explanatory diagram (part 1) illustrating a specific example of an operation of the information processing system 200;

FIG. 12 is an explanatory diagram (part 2) illustrating a specific example of the operation of the information processing system 200;

FIG. 13 is an explanatory diagram (part 3) illustrating a specific example of the operation of the information processing system 200;

FIG. 14 is an explanatory diagram (part 4) illustrating a specific example of the operation of the information processing system 200;

FIG. 15 is an explanatory diagram (part 5) illustrating a specific example of the operation of the information processing system 200;

FIG. 16 is an explanatory diagram (part 6) illustrating a specific example of the operation of the information processing system 200;

FIG. 17 is an explanatory diagram (part 1) illustrating an example of an effect by the information processing device 100;

FIG. 18 is an explanatory diagram (part 2) illustrating an example of the effect by the information processing device 100;

FIG. 19 is an explanatory diagram (part 3) illustrating an example of the effect by the information processing device 100;

FIG. 20 is a flowchart illustrating an example of a transfer processing procedure;

FIG. 21 is a flowchart illustrating an example of a calculation processing procedure;

FIG. 22 is a flowchart illustrating an example of a setting processing procedure;

FIG. 23 is a flowchart illustrating an example of a determination processing procedure; and

FIG. 24 is a flowchart illustrating an example of a reception processing procedure.

### DESCRIPTION OF EMBODIMENTS

For example, there is related art that acquires test data and extracts data related to an abnormality from the test data on the basis of a threshold used when the abnormality is detected. Furthermore, for example, there is a technique for creating a correlation coefficient matrix for each of test time-series data and reference normal time-series data and creating a sparse precision matrix that is an inverse matrix from each correlation coefficient matrix. Furthermore, for example, there is a technique for reading read data including management information from a storage unit when a read request is input, referring to the management information, and outputting only non-zero data included in a predetermined range of block lines.

However, with the related art, there is a case where improvement of a measurement frequency rather causes deterioration in accuracy for specifying the temporal change in the feature value. For example, if all the feature values are intended to be transmitted to the data management device when the measurement frequency is improved, a buffer easily becomes tight, the feature values are easily lost, and this may cause the deterioration in the accuracy for specifying the temporal change in the feature value.

In one aspect, an object of the embodiment is to enable to accurately specify a temporal change in a feature value. [0010] Hereinafter, an embodiment of an information processing program, an information processing method, and an information processing device will be described in detail with reference to the drawings.

(Example of Information Processing Method According to Embodiment)

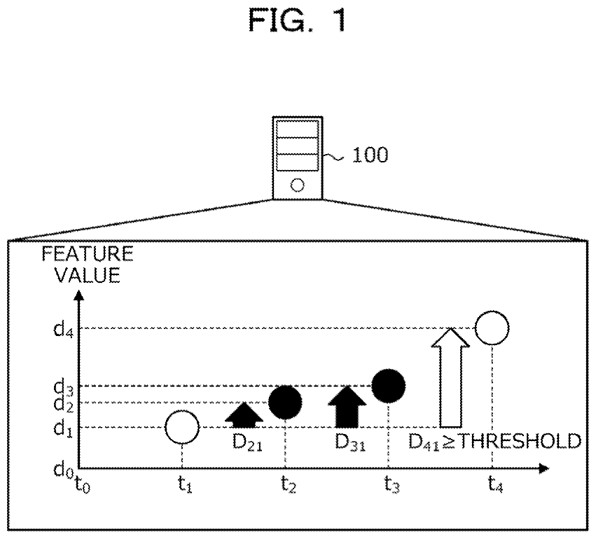

FIG. 1 is an explanatory diagram illustrating one example of an information processing method according to an embodiment. An information processing device 100 is a computer that determines whether or not a measured feature value is set as a transfer target to be transferred to a storage destination. The feature value is, for example, a value indicating a usage status of a resource of a central processing unit (CPU), a memory, or the like. The storage destination is, for example, another computer that analyzes a temporal change in the feature value.

Typically, there has been a system in which a data collection device measures some feature values regarding a measurement target, temporarily stores the measured feature value in a buffer, and transmits the stored feature value to a data management device, and makes a DB included in the data management device store the transmitted feature value. The measurement target is, for example, a provision device that provides some kind of service to a user.

The data management device may analyze a performance, a situation, or the like of the measurement target, for example, by analyzing a temporal change in the received feature value. Specifically, for example, the data management device may detect performance deterioration, a failure, or the like of a service provided by the provision device to be a measurement target or may estimate a cause of occurrence of the performance deterioration, the failure, or the like of the service provided by the provision device to be the measurement target.

Here, in order to enable to analyze the temporal change in the feature value in detail, it may be desired that the data management device can accurately specify the temporal change in the feature value. On the other hand, it is considered that the data collection device can accurately specify the temporal change in the feature value by increasing a measurement frequency of the feature value.

However, there is a case where it is difficult to enable to accurately specify the temporal change in the feature value. For example, there is a case where it is rather difficult to accurately specify the temporal change in the feature value by increasing the measurement frequency.

Specifically, for example, a required time for measuring the feature value and temporarily storing the feature value in the buffer tends to be shorter than a required time for transmitting the feature value to the data management device. Therefore, there is a problem in that, an attempt is made to transmit all the measured feature values to the data management device when the measurement frequency is increased, the feature values are not transmitted to the data management device yet, and the number of feature values that are not deleted from the buffer increases, and the buffer easily becomes tight. As a result, for example, it is considered that a next feature value is lost without being measured during processing for storing the measured feature value in a hard disk drive (HDD) or the like that has a slower access speed than the buffer, instead of the tight buffer. Furthermore, for example, it is considered that the measured feature value is lost without being temporarily stored in the buffer.

On the other hand, a method is considered for making it difficult to lose the feature value by transmitting the measured values, temporarily stored in the buffer, to the data management device after compressing the measured values.

For example, a method 1 is considered for making it difficult for the buffer to be tight by transmitting the measured values, temporarily stored in the buffer, to the data management device after compressing the measured values in a zip format so as to shorten the required time for transmitting to the data management device. As a result, this method 1 makes it difficult to lose the feature value and enables to accurately specify the temporal change in the feature value.

However, according to the method 1, there is a case where the feature value is still lost, and there is a case where it is difficult to accurately specify the temporal change in the feature value. For example, because the required time for compression and restoration in the zip format is relatively long, there is a case where it is not possible to prevent the buffer from being tight when the measurement frequency is increased.

Furthermore, for example, a method 2 is considered for making it difficult for the buffer to be tight by expressing the measured value that is temporarily stored in the buffer as a difference value from the previous measured value and compressing the measured value according to the difference method, and then, transmitting the measured value to the data management device so as to shorten the required time for transmitting the measured value to the data management device. As a result, this method 2 makes it difficult to lose the feature value and enables to accurately specify the temporal change in the feature value.

However, according to the method 2, there is a case where the feature value is still lost, and there is a case where it is difficult to accurately specify the temporal change in the feature value. For example, because a compression efficiency is easily decreased as the number of digits of the measured value is smaller, there is a case where it is not possible to prevent the buffer from being tight when the measurement frequency is increased.

Therefore, in the present embodiment, an information processing method will be described that can accurately specify the temporal change in the feature value by determining whether or not each feature value is set as a transfer target to be transferred to the storage destination.

In FIG. 1, (1-1), at each predetermined time point, the information processing device 100 measures a first type of a feature value regarding the corresponding time point. The feature value is, for example, a counter value. The counter value is, for example, a value that makes it possible to calculate a CPU usage rate, a memory usage rate, or the like. The feature value is stored, for example, in a temporary storage region included in the information processing device 100. For example, at each of the predetermined time points that have certain time intervals, the information processing device 100 measures the first type of the feature value regarding the corresponding time point.

In the example in FIG. 1, the information processing device 100 measures a feature value d₁ regarding a time point t₁ at the time point t₁. Here, the information processing device 100 may also determine the feature value d₁ that has been measured first as a transfer target to be transferred to the storage destination. Determining as the transfer target means, for example, enabling the feature value itself to be directly transferred to the storage destination so that the feature value can be stored in the storage destination.

Determining as the transfer target means enabling the feature value to be indirectly transferred to the storage destination so that the feature value can be stored in the storage destination by directly transferring information that can specify the feature value to the storage destination, for example. The information that can specify the feature value is, for example, an accumulated difference value of the feature value from another feature value regarding a time point in the past. When determining the feature value d₁ as the transfer target, the information processing device 100 transfers the feature value d₁ itself to the storage destination.

Furthermore, the information processing device 100 measures a feature value d₂ regarding a time point t₂ at the time point t₂. Furthermore, the information processing device 100 measures a feature value d₃ regarding a time point t₃ at the time point t₃. Furthermore, the information processing device 100 measures a feature value d₄ regarding a time point t₄ at the time point t₄.

(1-2) The information processing device 100 calculates an accumulated difference value from a first feature value regarding a first time point to a second feature value regarding a second time point after the first time point, of the measured feature values. The first time point is, for example, a time point when any one of the feature values is determined as a transfer target at the previous time. The first feature value is a feature value determined as the transfer target in the previous time. The information processing device 100, for example, sets each time point as a second time point at each predetermined time point and calculates an accumulated difference value from the first feature value regarding the first time point before the corresponding time point to a second feature value regarding the corresponding time point.

In the example in FIG. 1, the information processing device 100 calculates an accumulated difference value D₂₁ from the feature value d₁ regarding the time point t₁ to the feature value d₂ regarding the time point t₂ at the time point t₂. The information processing device 100 calculates an accumulated difference value D₃₁ from the feature value d₁ regarding the time point t₁ to the feature value d₃ regarding the time point t₃ at the time point t₃. The information processing device 100 calculates an accumulated difference value D₄₁ from the feature value d₁ regarding the time point t₁ to the feature value d₄ regarding the time point t₄ at the time point t₄.

(1-3) The information processing device 100 determines whether or not the second feature value is set as the transfer target to be transferred to the storage destination on the basis of a result of comparing the calculated accumulated difference value with a threshold. The threshold is set, for example, by a user. The threshold may also be, for example, variably automatically set. At each predetermined time point, the information processing device 100 determines whether or not the second feature value regarding the corresponding time point is set as the transfer target on the basis of the result of comparing the calculated accumulated difference value with the threshold, for example.

Here, as the accumulated difference value is smaller, the second feature value has a smaller difference from the first feature value. The second feature value has a property that easily reduces usefulness when the temporal change in the feature value is specified and easily lowers need to make it possible for the second feature value to be stored in the storage destination. Therefore, specifically, if the calculated accumulated difference value is less than the threshold, at each predetermined time point, the information processing device 100 determines that the second feature value regarding the corresponding time point is not set as the transfer target. On the other hand, specifically, for example, if the calculated accumulated difference value is equal to or more than the threshold, at each predetermined time point, the information processing device 100 determines that the second feature value regarding the corresponding time point is set as the transfer target.

In the example in FIG. 1, the information processing device 100 determines that the accumulated difference value D₂₁ is less than the threshold at the time point t₂ and determines that the feature value d₂ regarding the time point t₂ is not set as the transfer target. The information processing device 100 determines that the accumulated difference value D₃₁ is less than the threshold at the time point t₃ and determines that the feature value d₃ regarding the time point t₃ is not set as the transfer target. The information processing device 100 determines that the accumulated difference value D₄₁ is equal to or more than the threshold at the time point t₄ and determines that the feature value d₄ regarding the time point t₄ is set as the transfer target.

(1-4) The information processing device 100 enables the second feature value determined as the transfer target to be stored in the storage destination. For example, the information processing device 100 transfers the information, which makes it possible to specify the second feature value that is determined as the transfer target each time when the second feature value is determined as the transfer target, to the storage destination. In the example in FIG. 1, the information processing device 100 transfers the accumulated difference value D₄₁ that makes it possible to specify the feature value d₄ when the feature value d₄ is determined as the transfer target to the storage destination.

Furthermore, specifically, for example, there may be a case where the information processing device 100 sets the accumulated difference value D₂₁=0 at the time point t₂ when it is determined that the second feature value is not set as the transfer target and sets the accumulated difference value D₃₁=0 at the time point t₃ when it is determined that the second feature value is not set as the transfer target. In this case, specifically, for example, the information processing device 100 generates transfer data by generating accumulated difference value time-series data including the accumulated difference value D₂₁=0, the accumulated difference value D₃₁=0, the accumulated difference value D₄₁ and applying a compression method for extracting a non-zero element. Then, specifically, for example, the information processing device 100 transfers the generated transfer data to the storage destination.

As a result, the information processing device 100 can accurately specify the temporal change in the feature value in the storage destination. The information processing device 100 can prevent the temporary storage region from being tight than a case where the measured feature value is set as the transfer target each time when the feature value is measured. Therefore, the information processing device 100 can prevent to lose the feature value and accurately specify the temporal change in the feature value in the storage destination.

Furthermore, the information processing device 100 can determine whether or not the feature value is set as the transfer target in consideration of usefulness of the feature value, according to the comparison between the accumulated difference value and the threshold. Therefore, even there is a feature value that is not set as a transfer target, the information processing device 100 can still accurately specify the temporal change in the feature value in the storage destination.

Here, a case has been described where the storage destination is another computer different from the information processing device 100. However, the embodiment is not limited to this. For example, the storage destination may also be another storage region different from the temporary storage region included in the information processing device 100. For example, the another storage region may have a slower access speed than the temporary storage region.

Here, a case has been described where the information processing device 100 calculates the accumulated difference value at each predetermined time point and determines whether or not the second feature value regarding the corresponding time point is set as the transfer target. However, the embodiment is not limited to this. For example, there may be a case where, at the predetermined number of times when the predetermined time point comes, the information processing device 100 calculates the accumulated difference value from the first feature value regarding the first time point before the corresponding time point to the second feature value regarding each of the predetermined time points from the first time point to the corresponding time point. In this case, the information processing device 100 determines whether or not the second feature value regarding each predetermined time point is set as the transfer target.

Here, a case has been described where the information processing device 100 transfers the information that can specify the second feature value determined as the transfer target to the storage destination each time when the second feature value is determined as the transfer target. However, the embodiment is not limited to this. For example, there may also be a case where, each time when an amount of the second feature value to be transferred is equal to or more than a certain value, the information processing device 100 collectively transfers the information that can specify each second feature value to be transferred to the storage destination.

(Example of Information Processing System 200)

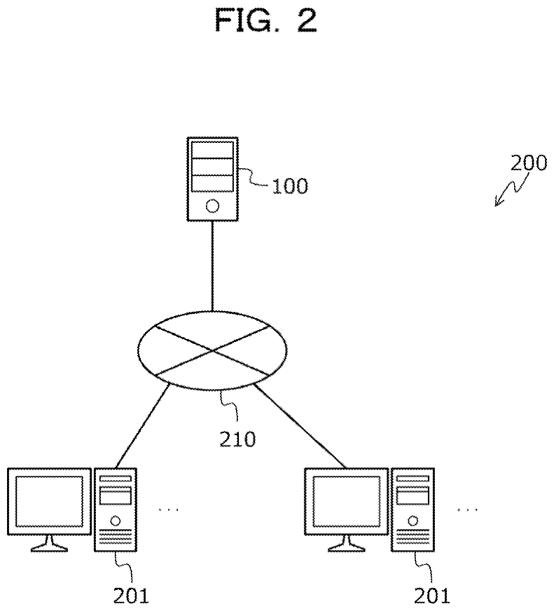

Next, an example of an information processing system 200 to which the information processing device 100 illustrated in FIG. 1 is applied will be described with reference to FIG. 2.

FIG. 2 is an explanatory diagram illustrating an example of the information processing system 200. In FIG. 2, the information processing system 200 includes the information processing device 100 and an information management device 201.

In the information processing system 200, the information processing device 100 and the information management device 201 are connected via a wired or wireless network 210. The network 210 is, for example, a local area network (LAN), a wide area network (WAN), the Internet, or the like.

The information processing device 100 is a computer that measures each of a plurality of types of feature values regarding a predetermined time point at each corresponding time point. The feature value is, for example, a counter value. The counter value is, for example, a value that makes it possible to calculate a CPU usage rate, a memory usage rate, or the like.

When measuring each type of the feature value regarding the predetermined time point, the information processing device 100 stores feature value data including each type of the measured feature value regarding the predetermined time point in a buffer that has a relatively high access speed. In a case where the buffer is tight, the information processing device 100 stores the feature value data including each type of the measured feature value regarding the predetermined time point in a disk that has a relatively slow access speed or the like, instead of the buffer. For example, when it is unnecessary to hold the feature value data, the feature value data is deleted from the buffer.

At each predetermined time point, the information processing device 100 determines whether or not each type of the feature value regarding the corresponding time point included in the feature value data is set as the transfer target. For example, at each predetermined time point and for each type, the information processing device 100 calculates an accumulated difference value from the corresponding type of the feature value regarding a time point previous to the corresponding time point to the corresponding type of the feature value regarding the corresponding time point. The information processing device 100 generates accumulated difference value data including the accumulated difference value calculated for each type at each predetermined time point.

When generating the accumulated difference value data, the information processing device 100 stores the generated accumulated difference value data in a buffer that has a relatively high access speed. In a case where the buffer is tight, the information processing device 100 stores the generated accumulated difference value data in a disk that has a relatively slow access speed or the like, instead of the buffer. For example, when it is unnecessary to hold the accumulated difference value data, the accumulated difference value data is deleted from the buffer.

For example, at each predetermined time point and for each type, the information processing device 100 determines whether or not the corresponding type of the feature value regarding the corresponding time point is set as a transfer target on the basis of the generated accumulated difference value data. For example, at each predetermined time point, the information processing device 100 overwrites the accumulated difference value, corresponding to any one type of feature value regarding the corresponding time point, determined not to be set as the transfer target, in the generated accumulated difference value data, to zero.

For example, the information processing device 100 compresses the accumulated difference value data according to a compression method for extracting non-zero and generates the transfer data. The information processing device 100 transmits the generated transfer data to the information management device 201. For example, the information processing device 100 is a server, a personal computer (PC), or the like.

The information management device 201 is a computer that manages the feature value and analyzes the feature value. The information management device 201 receives the transfer data from the information processing device 100. The information management device 201 restores the accumulated difference value data on the basis of the received transfer data. At each predetermined time point, the information management device 201 restores each type of the feature value regarding the corresponding time point on the basis of the restored accumulated difference value data.

The information management device 201 analyzes each type of the restored feature value regarding the corresponding time point at each predetermined time point and calculates a CPU usage rate, a memory usage rate, or the like. The information management device 201 analyzes a state or the like of the information processing device 100 on the basis of the calculated CPU usage rate, memory usage rate, or the like. The information processing device 100 outputs the analyzed result in a manner that allows an administrator to refer to the result. The information management device 201 is, for example, a server, a PC, or the like.

(Hardware Configuration Example of Information Processing Device 100)

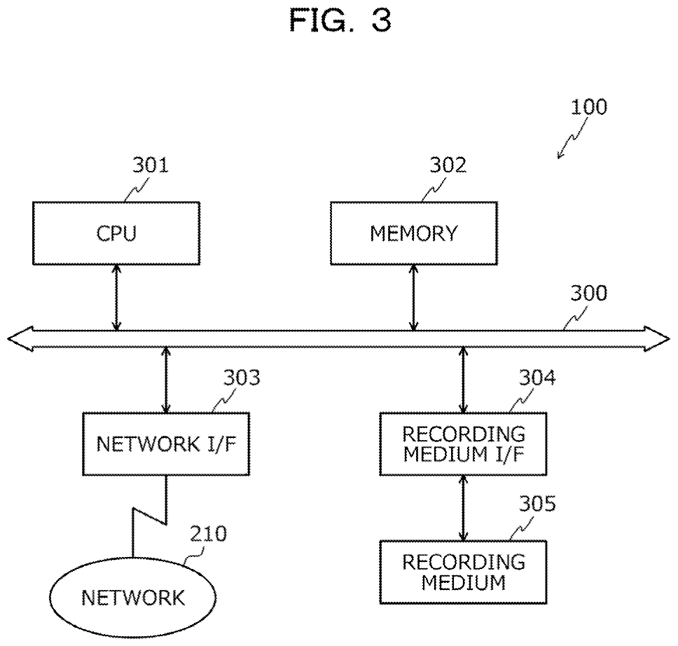

Next, a hardware configuration example of the information processing device 100 will be described with reference to FIG. 3.

FIG. 3 is a block diagram illustrating a hardware configuration example of the information processing device 100. In FIG. 3, the information processing device 100 includes a CPU 301, a memory 302, a network interface (I/F) 303, a recording medium I/F 304, and a recording medium 305. Furthermore, the components are connected to one another by a bus 300.

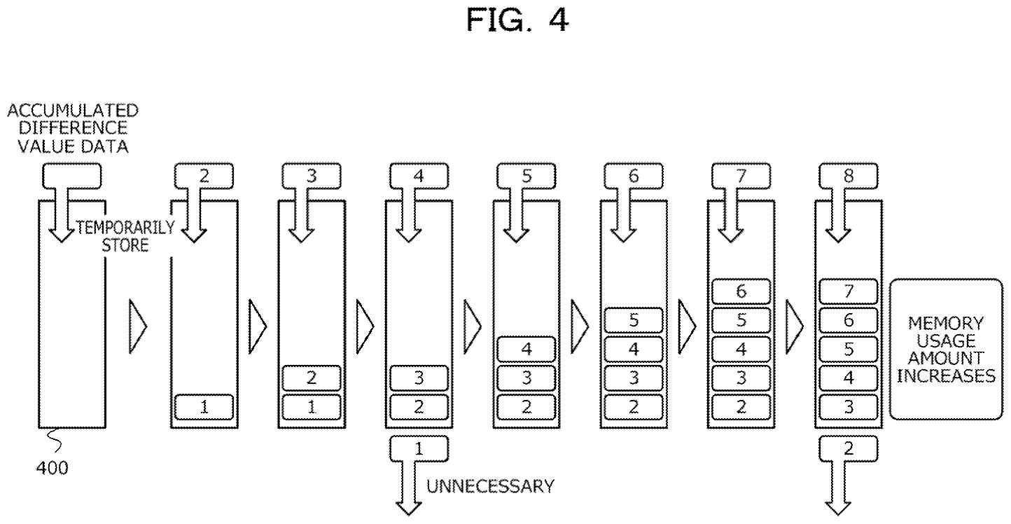

Here, the CPU 301 performs overall control of the information processing device 100. For example, the memory 302 includes a read only memory (ROM), a random access memory (RAM), a flash ROM, and the like. Specifically, for example, the flash ROM or the ROM stores various programs, and the RAM is used as a work area for the CPU 301. Furthermore, for example, the RAM implements a buffer 400 to be described later with reference to FIG. 4 that temporarily stores each of the plurality of types of feature values regarding the predetermined time point. The programs stored in the memory 302 are loaded into the CPU 301 to cause the CPU 301 to execute coded processing.

The network I/F 303 is connected to the network 210 through a communication line, and is connected to another computer through the network 210. Then, the network I/F 303 manages an interface between the network 210 and the inside and controls input and output of data to and from the another computer. The network I/F 303 is, for example, a modem, a LAN adapter, and the like.

The recording medium I/F 304 controls reading and writing of data from and to the recording medium 305 under the control of the CPU 301. For example, the recording medium I/F 304 is a disk drive, a solid state drive (SSD), a universal serial bus (USB) port, or the like. The recording medium 305 is a nonvolatile memory that stores data written under the control of the recording medium I/F 304. For example, the recording medium 305 is a disk, a semiconductor memory, a USB memory, or the like. The recording medium 305 may also be attachable to and detachable from the information processing device 100.

For example, the information processing device 100 may also include a keyboard, a mouse, a display, a printer, a scanner, a microphone, a speaker, or the like in addition to the components described above. Furthermore, the information processing device 100 may also include a plurality of recording medium I/Fs 304 and recording media 305. Furthermore, the information processing device 100 does not need to include the recording medium I/F 304 or the recording medium 305.

(Example of Storage Content of Buffer 400)

Next, an example of storage content of the buffer 400 will be described with reference to FIG. 4.

FIG. 4 is an explanatory diagram illustrating an example of the storage content of the buffer 400. As illustrated in FIG. 4, for example, the buffer 400 temporarily stores the accumulated difference value data regarding the predetermined time point. When the information processing device 100 does not need to hold the accumulated difference value data regarding the predetermined time point, the accumulated difference value data is deleted from the buffer 400. If a speed at which the accumulated difference value data is added to the buffer 400 is faster than a speed at which the accumulated difference value data becomes unnecessary, a memory usage amount of the buffer 400 easily increases, and the buffer 400 easily becomes tight. For example, when the accumulated difference value data is transmitted to the information management device 201 that is the storage destination, it is unnecessary to hold the accumulated difference value data.

(Hardware Configuration Example of Information Management Device 201)

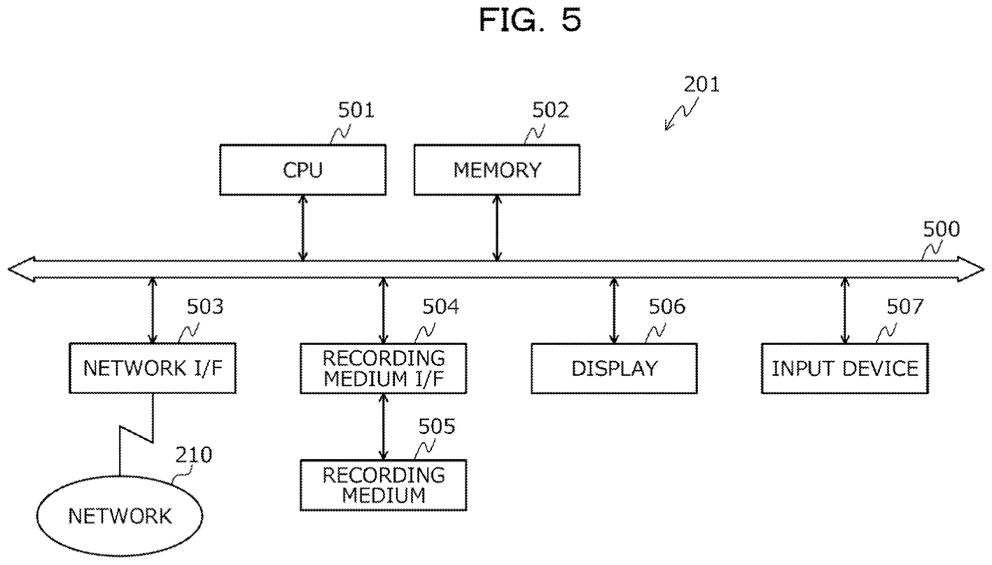

Next, a hardware configuration example of the information management device 201 included in the information processing system 200 illustrated in FIG. 2 will be described with reference to FIG. 5.

FIG. 5 is a block diagram illustrating the hardware configuration example of the information management device 201. In FIG. 5, the information management device 201 includes a CPU 501, a memory 502, a network I/F 503, a recording medium I/F 504, a recording medium 505, a display 506, and an input device 507. Furthermore, the components are connected to one another via a bus 500.

Here, the CPU 501 performs overall control of the information management device 201. The memory 502 includes, for example, a ROM, a RAM, a flash ROM, or the like. Specifically, for example, the flash ROM or the ROM stores various programs, while the RAM is used as a work area for the CPU 501. The programs stored in the memory 502 are loaded into the CPU 501 to cause the CPU 501 to execute coded processing.

The network I/F 503 is connected to the network 210 through a communication line, and is connected to another computer through the network 210. Then, the network I/F 503 manages an interface between the network 210 and the inside, and controls input and output of data to and from another computer. The network I/F 503 is, for example, a modem, a LAN adapter, and the like.

The recording medium I/F 504 controls reading and writing of data from and to the recording medium 505 under the control of the CPU 501. The recording medium I/F 504 is, for example, a disk drive, an SSD, a USB port, or the like. The recording medium 505 is a nonvolatile memory that stores data written under the control of the recording medium I/F 504. The recording medium 505 is, for example, a disk, a semiconductor memory, a USB memory, or the like. The recording medium 505 may also be attachable to and detachable from the information management device 201.

The display 506 displays data such as a document, an image, or function information, as well as a cursor, an icon, or a tool box. The display 506 is, for example, a cathode ray tube (CRT), a liquid crystal display, an organic electroluminescence (EL) display, or the like. The input device 507 has keys used to input characters, numbers, various instructions, and the like, and inputs data. The input device 507 may also be a keyboard, a mouse, or the like, or may also be a touch-panel input pad, a numeric keypad, or the like.

The information management device 201 may also include, for example, a printer, a scanner, a microphone, a speaker, and the like, in addition to the above-described components. Furthermore, the information management device 201 may also include a plurality of recording medium I/Fs 504 and recording media 505. Furthermore, the information management device 201 does not need to include the recording medium I/F 504 or the recording medium 505.

(Functional Configuration Example of Information Processing Device 100)

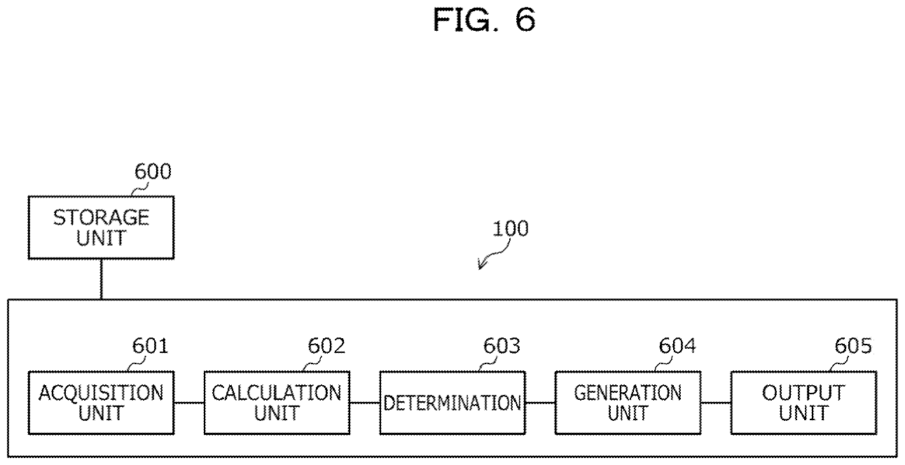

Next, a functional configuration example of the information processing device 100 will be described with reference to FIG. 6.

FIG. 6 is a block diagram illustrating a functional configuration example of the information processing device 100. The information processing device 100 includes a storage unit 600, an acquisition unit 601, a calculation unit 602, a determination unit 603, a generation unit 604, and an output unit 605.

The storage unit 600 is implemented by, for example, the storage region such as the memory 302 or the recording medium 305 illustrated in FIG. 3. Hereinafter, a case will be described where the storage unit 600 is included in the information processing device 100. However, the embodiment is not limited to this. For example, there may also be a case where the storage unit 600 is included in a device different from the information processing device 100 and the information processing device 100 can refer to the storage content of the storage unit 600.

The acquisition unit 601 to the output unit 605 function as an example of a control unit. Specifically, for example, the acquisition unit 601 through the output unit 605 implement functions thereof by causing the CPU 301 to execute a program stored in the storage region such as the memory 302 or the recording medium 305 or by the network I/F 303 illustrated in FIG. 3. A processing result of each functional unit is stored in the storage region such as the memory 302 or the recording medium 305 illustrated in FIG. 3, for example.

The storage unit 600 stores various types of information to be referred to or updated in the processing of each functional unit. For example, at each predetermined time point, the storage unit 600 stores each of one or more types of the feature values regarding the corresponding time point. The feature value is, for example, a counter value. The counter value is, for example, a value that makes it possible to calculate a CPU usage rate, a memory usage rate, or the like. Specifically, for example, at each predetermined time point, the storage unit 600 stores feature value data regarding the corresponding time point including each type of the feature value regarding the corresponding time point.

For example, at each predetermined time point, the storage unit 600 stores each of one or more types of the accumulated difference values regarding the corresponding time point. Any one type of accumulated difference values regarding the predetermined time point is an accumulated difference value from the corresponding type of the feature value regarding a time point previous to the corresponding time point to the corresponding type of the feature value regarding the corresponding time point. Specifically, for example, at each predetermined time point, the storage unit 600 stores the accumulated difference value data regarding the corresponding time point including each type of the accumulated difference value regarding the corresponding time point.

The storage unit 600 stores, for example, a threshold corresponding to the first type. The threshold corresponding to the first type is, for example, preset by a user. The threshold corresponding to the first type may also be set, for example, by the determination unit 603. The storage unit 600 stores, for example, a threshold corresponding to each type. The threshold corresponding to each type may also be a common value. The threshold corresponding to each type is, for example, preset by a user. The threshold corresponding to each type may also be set, for example, by the determination unit 603.

The acquisition unit 601 acquires various types of information to be used for the processing of each functional unit. The acquisition unit 601 stores the acquired various types of information in the storage unit 600 or outputs the acquired various types of information to each functional unit. Furthermore, the acquisition unit 601 may also output the various types of information stored in the storage unit 600 to each functional unit. The acquisition unit 601 acquires the various types of information on the basis of, for example, a user's operation input. The acquisition unit 601 may also receive various types of information from a device different from the information processing device 100, for example.

For example, at each predetermined time point, the acquisition unit 601 acquires the first type of the feature value regarding the corresponding time point. Specifically, for example, at each predetermined time point, the acquisition unit 601 acquires the first type of the feature value regarding the corresponding time point by measuring the first type of the feature value. The predetermined time points indicate, for example, a plurality of time points separated by a certain time interval. For example, at each predetermined time point, the acquisition unit 601 acquires each of the plurality of types of the feature values regarding the corresponding time point. Specifically, for example, at each predetermined time point, the acquisition unit 601 acquires each of the plurality of types of the feature values regarding the corresponding time point by measuring the feature values.

The acquisition unit 601 may also accept a start trigger to start processing of any one of functional units. The start trigger is, for example, a predetermined operation input made by the user. The start trigger may also be, for example, reception of predetermined information from another computer. The start trigger may also be, for example, output of predetermined information by any one of the functional units.

The calculation unit 602 calculates at least any one type of accumulated difference values at each predetermined time point. The calculation unit 602 calculates, for example, an accumulated difference value from the first feature value regarding the first time point to the second feature value regarding the second time point of the first type of the measured feature values. The second time point is a time point after the first time point. Specifically, for example, the calculation unit 602 calculates the accumulated difference value from the first type of the first feature value, regarding the first time point, determined as the transfer target at the previous time to the first type of the second feature value regarding the second time point after the first time point.

More specifically, for example, the calculation unit 602 treats the corresponding time point as the second time point at each predetermined time point. More specifically, for example, at each predetermined time point, before the corresponding time point, the calculation unit 602 calculates the accumulated difference value from the first type of the first feature value, regarding the first time point, determined as the transfer target at the previous time to the first type of the second feature value regarding the corresponding time point treated as the second time point. As a result, the calculation unit 602 can evaluate usefulness of the second feature value and obtain information to be a guideline for determining whether or not the second feature value is set as the transfer target.

For example, for each type, the calculation unit 602 calculates the accumulated difference value from the corresponding type of the first feature value regarding the first time point to the corresponding type of the second feature value regarding the second time point of the corresponding types, of the measured feature values. Specifically, for example, for each type, the calculation unit 602 calculates the accumulated difference value from the corresponding type of the first feature value, regarding the first time point, determined as the transfer target at the previous time to the corresponding type of the second feature value regarding the second time point.

More specifically, for example, the calculation unit 602 treats the corresponding time point as the second time point at each predetermined time point. More specifically, for example, at each predetermined time point, the calculation unit 602 specifies the corresponding type of the first feature value, regarding the first time point, determined as the transfer target at the previous time, for each type, before the corresponding time point. More specifically, for example, at each predetermined time point, the calculation unit 602 calculates the accumulated difference value from the specified first feature value to the corresponding type of the second feature value regarding the corresponding time point treated as the second time point, for each type. As a result, the calculation unit 602 can evaluate usefulness of the second feature value and obtain information to be a guideline for determining whether or not the second feature value is set as the transfer target.

The determination unit 603 sets a threshold corresponding to the first type. For example, the determination unit 603 acquires an accumulated difference value corresponding to the first type of a third feature value regarding a third time point before the first time point, determined as the transfer target before the first time point. The accumulated difference value corresponding to the third feature value is an accumulated difference value from a fourth feature value regarding a fourth time point further before the third time point to the third feature value. Then, for example, the determination unit 603 sets the threshold corresponding to the first type on the basis of the acquired accumulated difference value and an empty state of a storage region where the measured feature value is accumulated. As a result, the determination unit 603 can easily set an appropriate threshold and can easily and accurately determine whether or not the first type of the second feature value is set as the transfer target.

The determination unit 603 sets a threshold corresponding to each type. For example, for each type, the determination unit 603 acquires an accumulated difference value corresponding to the corresponding type of the third feature value, regarding the third time point before the first time point, determined as the transfer target before the first time point. The accumulated difference value corresponding to any one type of the third feature value is an accumulated difference value from the corresponding type of the fourth feature value regarding the fourth time point further before the third time point to the corresponding type of the third feature value. Then, for example, for each type, the determination unit 603 sets a threshold corresponding to the corresponding type on the basis of the acquired accumulated difference value and the empty state of the storage region where the measured feature value is accumulated. As a result, the determination unit 603 can easily set an appropriate threshold and can easily and accurately determine whether or not the first type of the second feature value is set as the transfer target.

The determination unit 603 determines whether or not the second feature value is set as the transfer target on the basis of a result of comparing the calculated accumulated difference value with the threshold. Determining as the transfer target means, for example, making it possible to store the second feature value in the storage destination. The storage destination is, for example, a device different from the information processing device 100. Specifically, for example, the storage destination is the information management device 201. The storage destination may also be a storage region, included in the information processing device 100, different from the buffer.

Determining as the transfer target means, specifically, for example, that the second feature value can be indirectly transferred to the storage destination by making is possible to directly transfer an accumulated difference value from the first feature value regarding the time point in the past to the second feature value to the storage destination as information that can specify the second feature value. Furthermore, specifically, for example, determining as the transfer target may also mean making it possible to directly transfer the second feature value itself to the storage destination.

For example, regarding the first type of the second feature value, the determination unit 603 determines whether or not the first type of the second feature value is set as the transfer target on the basis of the result of comparing the calculated accumulated difference value with the threshold. Specifically, for example, in a case where the calculated accumulated difference value is equal to or more than the threshold, the determination unit 603 determines that the first type of the second feature value is set as the transfer target. On the other hand, specifically, for example, in a case where the calculated accumulated difference value is less than the threshold, the determination unit 603 determines that the first type of the second feature value is not set as the transfer target. As a result, the determination unit 603 can determine whether or not the second feature value is set as the transfer target in consideration of usefulness of the first type of the second feature value in the storage destination.

For example, regarding the first type of the second feature value, the determination unit 603 may also determine whether or not the first type of the second feature value is set as the transfer target on the basis of the result of comparing the calculated accumulated difference value with the threshold corresponding to the first type. As a result, the determination unit 603 can determine whether or not the second feature value is set as the transfer target in consideration of usefulness of the first type of the second feature value in the storage destination. Furthermore, the determination unit 603 can use the threshold corresponding to the first type and can accurately determine whether or not the second feature value is set as the transfer target.

For example, for each type, the determination unit 603 determines whether or not the corresponding type of the second feature value is set as the transfer target on the basis of the result of comparing the calculated accumulated difference value with the threshold. Specifically, for example, regarding any one type, in a case where the calculated accumulated difference value is equal to or more than the threshold, the determination unit 603 determines that the corresponding type of the second feature value is set as the transfer target. On the other hand, specifically, for example, regarding any one type, in a case where the calculated accumulated difference value is less than the threshold, the determination unit 603 determines that the corresponding type of the second feature value is not set as the transfer target. As a result, the determination unit 603 can determine whether or not each type of the second feature value is set as the transfer target in consideration of usefulness of each type of the second feature value in the storage destination.

Regarding each type, the determination unit 603 may also determine whether or not the corresponding type of the second feature value is set as the transfer target on the basis of the result of comparing the calculated accumulated difference value with a threshold corresponding to the corresponding type. As a result, the determination unit 603 can determine whether or not each type of the second feature value is set as the transfer target in consideration of usefulness of each type of the second feature value in the storage destination.

The generation unit 604 generates the transfer data. For example, the generation unit 604 generates the transfer data including the first type of the second feature value determined as the transfer target of the first type, of the second feature value measured at each predetermined time point. For example, the generation unit 604 may also discard the first type of the second feature value determined not to be set as the transfer target, among the first type of the second feature values measured at each predetermined time point. As a result, the generation unit 604 can generate transfer data having a relatively small size. Furthermore, the generation unit 604 can accurately specify the temporal change in the first type of the feature value in the storage destination according to the transfer data.

For example, the generation unit 604 generates transfer data including any one type of the second feature value determined as the transfer target, of the respective types of the second feature values measured at each predetermined time point. For example, the generation unit 604 may also discard any one type of the second feature value determined not to be set as a transfer target, among the respective types of the second feature values measured at each predetermined time point. As a result, the generation unit 604 can generate transfer data having a relatively small size. Furthermore, the generation unit 604 can accurately specify the temporal change in each type of the feature value in the storage destination according to the transfer data.

For example, in a case of determining that the first type of the second feature value is set as the transfer target, the generation unit 604 includes an accumulated difference value corresponding to the first type of the second feature value determined as the transfer target in the transfer data. Furthermore, for example, in a case of determining that the first type of the second feature value is not set as the transfer target, the generation unit 604 converts an accumulated difference value corresponding to the first type of the second feature value determined not to be set as the transfer target into zero and includes the accumulated difference value converted into zero in the transfer data. As a result, the generation unit 604 can generate transfer data having a relatively small size. Furthermore, the generation unit 604 can accurately specify the temporal change in the first type of the feature value in the storage destination according to the transfer data.

For example, in a case of determining that any one type of the second feature value is set as a transfer target, the generation unit 604 includes an accumulated difference value corresponding to the corresponding type of the second feature value determined as the transfer target in the transfer data. Furthermore, for example, in a case of determining that any one type of the second feature value is not set as the transfer target, the generation unit 604 converts an accumulated difference value corresponding to the corresponding type of the second feature value determined not to be set as the transfer target into zero and includes the accumulated difference value converted into zero in the transfer data. As a result, the generation unit 604 can generate transfer data having a relatively small size. Furthermore, the generation unit 604 can accurately specify the temporal change in the corresponding type of the feature value in the storage destination according to the transfer data.

The generation unit 604 may also apply a compression method for extracting non-zero to the transfer data. As a result, the generation unit 604 can reduce a size of the transfer data. For example, because the accumulated difference value corresponding to any one type of the second feature value is converted into zero, the generation unit 604 can easily reduce the size of the transfer data. For example, the generation unit 604 can reduce a time required when the transfer data is transferred to the storage destination.

The generation unit 604 deletes the second feature value corresponding to the accumulated difference value that has been transferred to the storage destination from the storage region where the measured feature value is accumulated. The generation unit 604 may also delete the accumulated difference value that has been transferred to the storage destination, from the storage region where the accumulated difference value is accumulated. As a result, the generation unit 604 can increase an empty size of the storage region and prevent the storage region from being tight. As a result, the generation unit 604 can prevent a situation in which the storage region becomes tight and it is difficult to measure the feature value.

If the feature value that has been measured first is not transferred yet, the generation unit 604 may also include the feature value in the transfer data. As a result, the generation unit 604 can specify the feature value to be a reference in the storage destination. Therefore, the generation unit 604 can specify a second and subsequent feature values on the basis of the accumulated difference value.

The output unit 605 outputs a processing result of at least one of the functional units. An output format is, for example, display on a display, print output to a printer, transmission to an external device by the network I/F 303, or storage in the storage region such as the memory 302 or the recording medium 305. As a result, the output unit 605 may allow to notify the user of the processing result of at least one of the functional units and may improve the convenience of the information processing device 100. The output unit 605 transfers the generated transfer data to the storage destination. As a result, the output unit 605 can accurately specify the temporal change in the feature value in the storage destination.

(Specific Functional Configuration Example of Information Processing System 200)

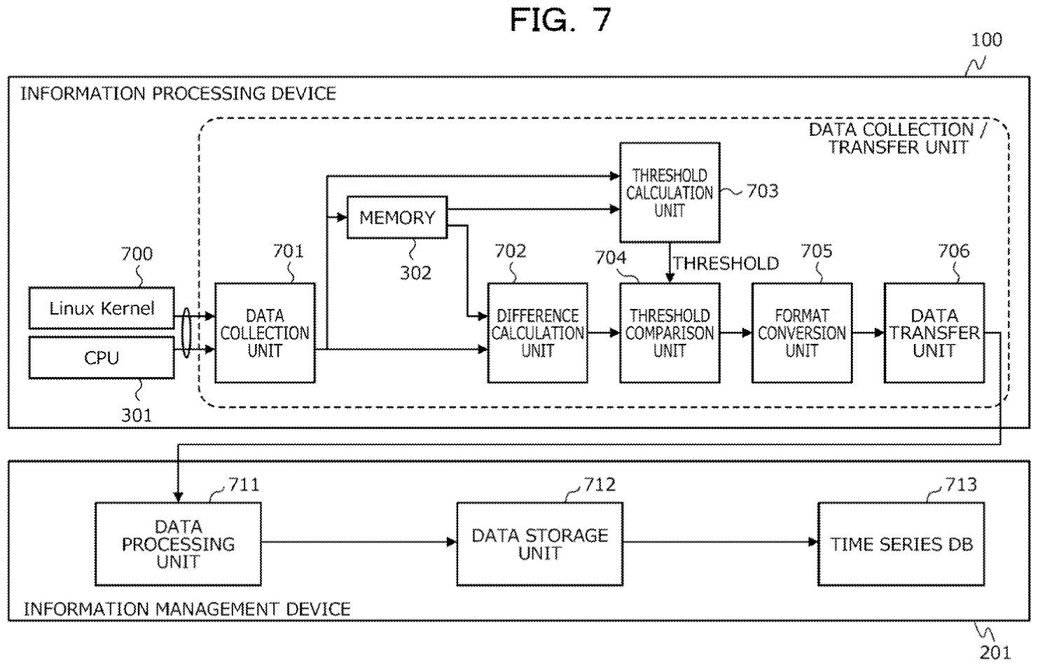

Next, a specific functional configuration example of the information processing system 200 will be described with reference to FIG. 7.

FIG. 7 is a block diagram illustrating a specific functional configuration example of the information processing system 200. In FIG. 7, the information processing device 100 includes a data collection unit 701, a difference calculation unit 702, a threshold calculation unit 703, a threshold comparison unit 704, a format conversion unit 705, and a data transfer unit 706. Specifically, for example, the data collection unit 701 through the data transfer unit 706 implement functions thereof by causing the CPU 301 to execute a program stored in the storage region such as the memory 302, the recording medium 305, or the like or by the network I/F 303 illustrated in FIG. 3.

The information management device 201 includes a data processing unit 711, a data storage unit 712, and a time series DB 713. Specifically, for example, the data processing unit 711 and the data storage unit 712 implement functions thereof by causing the CPU 501 to execute a program stored in the storage region such as the memory 502 or the recording medium 505, or by the network I/F 503 illustrated in FIG. 5.

The data collection unit 701 collects of each a plurality of types of counter values at each predetermined time point from the CPU 301 or a Kernel 700. The number of CPUs 301 may also be plural. The type indicates which element in which CPU 301 is related. The data collection unit 701 generates measurement data dₜ including each type of the collected counter value at each predetermined time point. The data collection unit 701 accumulates the generated measurement data dₜ at this time in the memory 302. The data collection unit 701 outputs the generated measurement data dₜ at this time to the difference calculation unit 702. The data collection unit 701 outputs the generated measurement data dₜ at this time to the threshold calculation unit 703.

The difference calculation unit 702 acquires the measurement data dₜ at this time from the data collection unit 701. The difference calculation unit 702 acquires reference measurement data dₜ′ from the memory 302. For each type, the reference measurement data dₜ′ includes the corresponding type of counter value determined as the transfer target at the previous time. The difference calculation unit 702 generates accumulated difference value data Dₜ including an accumulated difference value from each type of the counter value included in the measurement data dₜ at this time to the corresponding type of the counter value included in the reference measurement data dₜ′. The difference calculation unit 702 outputs the generated accumulated difference value data Dₜ to the threshold comparison unit 704.

The threshold calculation unit 703 acquires the measurement data dₜ at this time from the data collection unit 701. The threshold calculation unit 703 acquires reference accumulated difference value data Dₜ′ from the memory 302. For each type, the reference accumulated difference value data Dₜ′ includes the corresponding type of the accumulated difference value at the time when the corresponding type of the counter value is determined as the transfer target at the previous time. The threshold calculation unit 703 calculates a memory usage rate rₘₑₘ on the basis of the measurement data dₜ at this time. For each type, the difference calculation unit 702 calculates a threshold Thₜ corresponding to the corresponding type on the basis of the calculated memory usage rate rₘₑₘ and the corresponding type of the accumulated difference value included in the reference accumulated difference value data Dₜ′. The threshold calculation unit 703 outputs the threshold Thₜ corresponding to each type to the threshold comparison unit 704.

The threshold comparison unit 704 acquires the accumulated difference value data Dₜ from the difference calculation unit 702. The threshold comparison unit 704 acquires the threshold Thₜ corresponding to each type from the threshold calculation unit 703. The threshold comparison unit 704 determines whether or not each type of the accumulated difference value included in the accumulated difference value data Dₜ is equal to or more than the threshold Thₜ corresponding to the corresponding type. If any one type of the accumulated difference value included in the accumulated difference value data Dₜ is equal to or more than the threshold Thₜ corresponding to the corresponding type, the threshold comparison unit 704 determines the corresponding type of the counter value as the transfer target. The threshold comparison unit 704 overwrites the corresponding type of the counter value included in the reference measurement data dₜ′ with any one type of counter value determined as the transfer target. The threshold comparison unit 704 overwrites the corresponding type of the accumulated difference value included in the reference accumulated difference value data Dₜ′ with any one type of the accumulated difference value included in the accumulated difference value data Dₜ, equal to or more than the threshold Thₜ. If any one type of the accumulated difference value included in the accumulated difference value data Dₜ is less than the threshold Thₜ corresponding to the corresponding type, the threshold comparison unit 704 overwrites the corresponding type of the accumulated difference value with zero. The threshold comparison unit 704 outputs the accumulated difference value data Dₜ to the format conversion unit 705.

The format conversion unit 705 acquires the accumulated difference value data Dₜ from the threshold comparison unit 704. The format conversion unit 705 generates transfer data by applying the compression method for extracting non-zero to the accumulated difference value data Dₜ. The format conversion unit 705 outputs the transfer data to the data transfer unit 706. The data transfer unit 706 acquires the transfer data from the format conversion unit 705. The data transfer unit 706 transfers the transfer data to the information management device 201.

The data processing unit 711 receives the transfer data from the information processing device 100. The data processing unit 711 restores the accumulated difference value data Dₜ on the basis of the transfer data. The data processing unit 711 restores the measurement data dₜ on the basis of the accumulated difference value data Dₜ. The data processing unit 711 processes the measurement data dₜ according to a data format to be stored in the time series DB 713. The data processing unit 711 outputs the processed measurement data dₜ to the data storage unit 712. The data storage unit 712 acquires the processed measurement data dₜ from the data processing unit 711. The data storage unit 712 stores the processed measurement data dₜ in the time series DB 713. As a result, the information processing device 100 can enable the information management device 201 to accurately specify the temporal change in each type of the counter value.

(Flow of Operation of Information Processing Device 100)

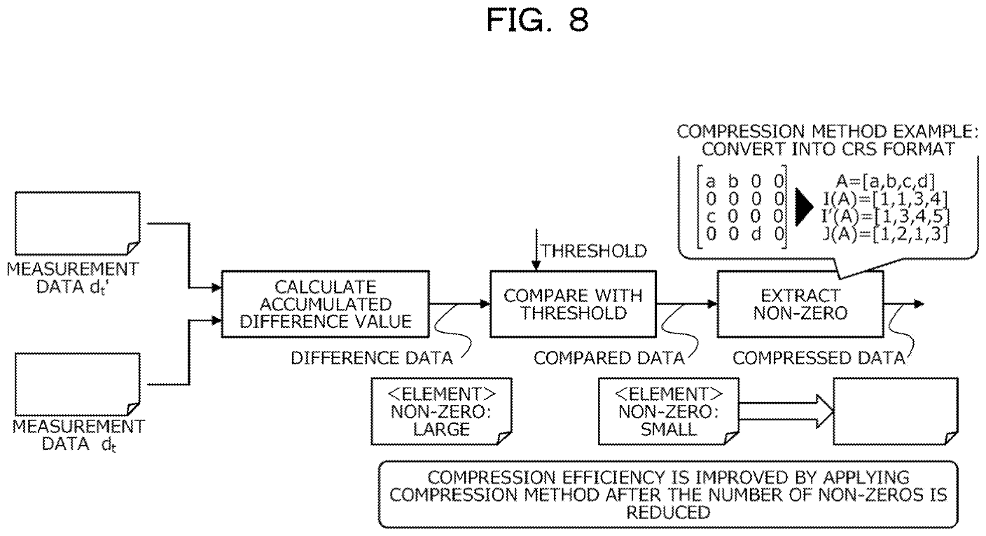

Next, a flow of an operation of the information processing device 100 will be described with reference to FIG. 8.

FIG. 8 is an explanatory diagram illustrating the flow of the operation of the information processing device 100. In FIG. 8, the information processing device 100 acquires measurement data dₜ at a predetermined time t. The measurement data dₜ is, for example, each of a plurality of types of counter values at the time t. The information processing device 100 acquires measurement data dₜ′ including the corresponding type of the counter value at a time point t′ when the corresponding type of the accumulated difference value is equal to or more than the corresponding type of the threshold at the previous time for each type, in response to acquisition of the measurement data dₜ. The measurement data dₜ′ is each of the plurality of types of the counter values at the time t′. The time t′ may also be different for each type.

The information processing device 100 calculates the accumulated difference value data Dₜ=the measurement data dₜ−the measurement data dₜ′. The accumulated difference value data Dₜ is each type of the accumulated difference value at the time t. One type of the accumulated difference value=the corresponding type of the counter value included in the measurement data dₜ−the corresponding type of the counter value included in the measurement data dₜ′ is satisfied. The accumulated difference value data Dₜ tends to include a relatively large number of non-zero accumulated difference values.

The information processing device 100 determines whether or not each type of the accumulated difference value included in the accumulated difference value data Dₜ is equal to or more than a threshold. The threshold may also be different, for example, for each type. If any one type of accumulated difference value is less than the threshold, the information processing device 100 overwrites the corresponding type of the accumulated difference value included in the accumulated difference value data Dₜ with zero. As a result, the information processing device 100 can make the accumulated difference value data Dₜ easily include zero, and can easily improve a compression efficiency.

The information processing device 100 generates compressed data by applying the compression method for extracting non-zero to the accumulated difference value data Dₜ. The compression method is, for example, a compression method for converting into a compressed row storage (CRS) format. As a result, the information processing device 100 can reduce a size of the compressed data. The information processing device 100 can reduce a time required when the compressed data is transferred to the storage destination and can make it difficult for the buffer to be tight.

(Example of Operation of Information Processing Device 100)

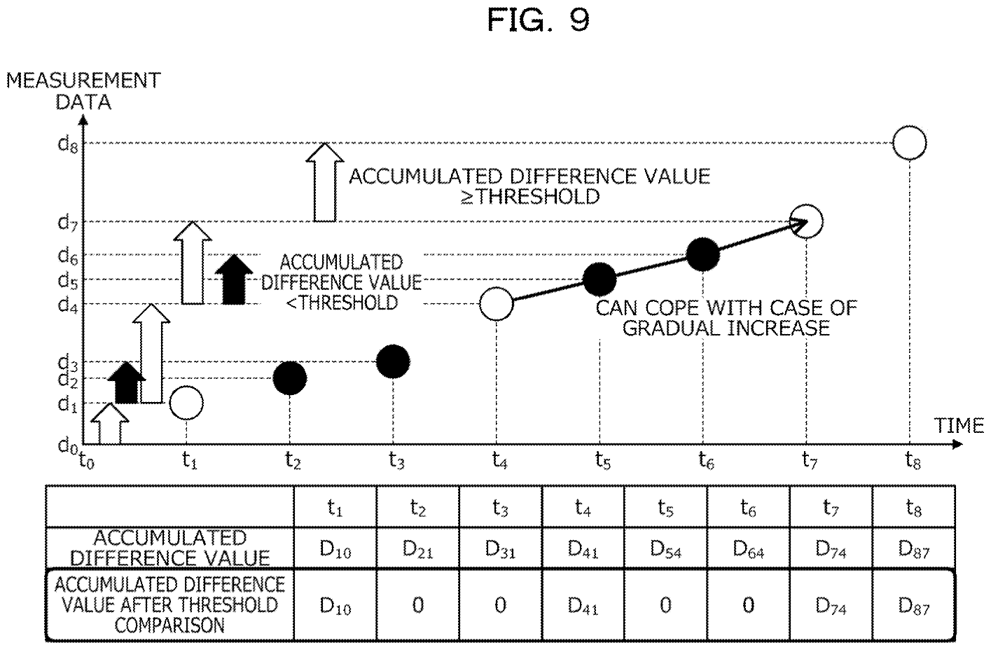

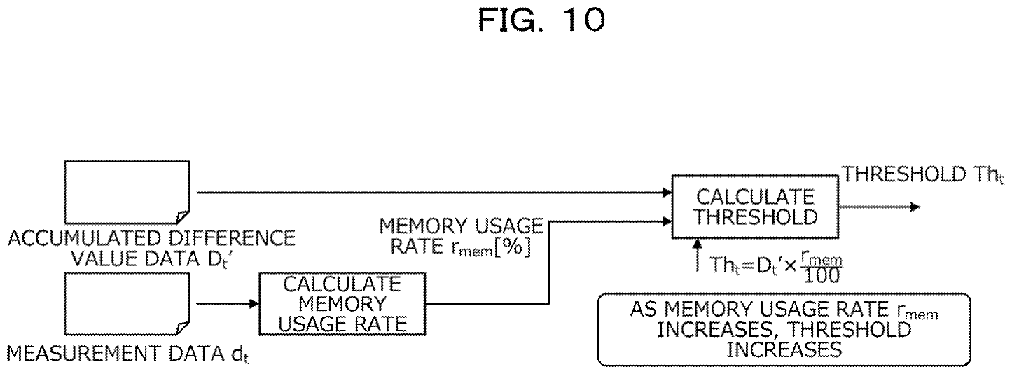

Next, an example of an operation of the information processing device 100 will be described with reference to FIGS. 9 and 10. In the following description, for simple description, a case will be described where the information processing device 100 measures only one type of the counter value and calculates only one type of the accumulated difference value.

FIGS. 9 and 10 are explanatory diagrams illustrating an example of the operation of the information processing device 100. In FIG. 9, the information processing device 100 calculates an accumulated difference value D₁₀ at a time t₁. For example, because there is no accumulated difference value equal to or more than a threshold at the previous time to be a reference, the accumulated difference value D₁₀ is an accumulated difference value with reference to zero. In the example in FIG. 9, the information processing device 100 leaves the accumulated difference value D₁o, because the accumulated difference value D₁₀ a threshold. The threshold is set by the information processing device 100. An example in which the information processing device 100 sets the threshold will be described later, specifically, for example, with reference to FIG. 10.

The information processing device 100 calculates an accumulated difference value D₂₁ at a time t₂. For example, the accumulated difference value D₂₁ is an accumulated difference value using the accumulated difference value D₁₀ that is equal to or more than the threshold at the previous time as a reference. In the example in FIG. 9, because the accumulated difference value D₂₁<the threshold, the information processing device 100 overwrites the accumulated difference value D₂₁ with zero. The threshold is set by the information processing device 100. Similarly, because an accumulated difference value D₃₁<a threshold at a time t₃, the information processing device 100 overwrites the accumulated difference value D₃₁ with zero. The threshold is set by the information processing device 100.

In this way, the information processing device 100 can overwrite the accumulated difference values D₂₁ and D₃₁ with zero and can make it difficult for the buffer to be tight.

The information processing device 100 calculates an accumulated difference value D₄₁ at a time t₄. For example, the accumulated difference value D₄₁ is an accumulated difference value using the accumulated difference value D₁₀ that is equal to or more than the threshold at the previous time as a reference. In the example in FIG. 9, the information processing device 100 leaves the accumulated difference value D₄₁, because the accumulated difference value D₄₁ a threshold. The threshold is set by the information processing device 100.

In this way, in a case where the counter value relatively largely changes from the time t₃ to the time t₄ and the accumulated difference value D₄₁ is equal to or more than the threshold, the information processing device 100 can leave the accumulated difference value D₄₁. Therefore, the information processing device 100 can selectively leave the accumulated difference value D₄₁ so as to accurately specify the temporal change in the counter value. For example, the information processing device 100 can selectively leave the accumulated difference value D₄₁ so that a relatively large change in the counter value can be specified.

The information processing device 100 calculates an accumulated difference value D₅₄ at a time t₅. For example, the accumulated difference value D₅₄ is an accumulated difference value using the accumulated difference value D₄₁ that is equal to or more than the threshold at the previous time as a reference. In the example in FIG. 9, because the accumulated difference value D₅₄<the threshold, the information processing device 100 overwrites the accumulated difference value D₅₄ with zero. The threshold is set by the information processing device 100. Similarly, because an accumulated difference value D₆₄<a threshold at a time t₆, the information processing device 100 overwrites the accumulated difference value D₆₄ with zero. The threshold is set by the information processing device 100.

In this way, the information processing device 100 can overwrite the accumulated difference values D₅₄ and D₅₄ with zero and can make it difficult for the buffer to be tight.

The information processing device 100 calculates an accumulated difference value D₇₄ at a time t₇. For example, the accumulated difference value D₇₄ is an accumulated difference value using the accumulated difference value D₄₁ that is equal to or more than the threshold at the previous time as a reference. In the example in FIG. 9, the information processing device 100 leaves the accumulated difference value D₇₄, because the accumulated difference value D₇₄ a threshold. The threshold is set by the information processing device 100.

In this way, in a case where the accumulated difference value D₇₄ is equal to or more than the threshold as a result of slightly changing the counter value without largely changing the counter value at one time from the time t₄ to the time t₇, the information processing device 100 can leave the accumulated difference value D₇₄. Therefore, the information processing device 100 can selectively leave the accumulated difference value D₇₄ so that the temporal change in the counter value can be accurately specified without depending on an individual difference magnitude between the counter value and another preceding counter value. For example, the information processing device 100 can selectively leave the accumulated difference value D₇₄ so as to specify that the counter value slightly increases and relatively largely changes from the time t₄ to the time t₇.

The information processing device 100 calculates an accumulated difference value D₈₇ at a time t₈. For example, the accumulated difference value D₈₇ is an accumulated difference value using the accumulated difference value D₇₄ that is equal to or more than the threshold at the previous time as a reference. In the example in FIG. 9, the information processing device 100 leaves the accumulated difference value D₈₇, because the accumulated difference value D₈₇ a threshold. The threshold is set by the information processing device 100.

In this way, when the counter value relatively largely changes, the information processing device 100 can leave the accumulated difference value D₈₇ regardless of whether or not the preceding accumulated difference value D₇₄ is left. Therefore, the information processing device 100 can selectively leave the accumulated difference value D₈₇ so as to accurately specify the temporal change in the counter value.

The information processing device 100 treats the accumulated difference value that is less than the threshold as zero when the accumulated difference value is transferred to the storage destination or does not transfer the accumulated difference value to the storage destination. As a result, the information processing device 100 can reduce a transfer amount to 4/8 than a case where the all the calculated accumulated difference values are transferred to the storage destination and can reduce a time required for transfer. Alternatively, the information processing device 100 can efficiently compress an accumulated difference value group of which 4/8 is zero and transfer the accumulated difference value group to the storage destination, and can reduce the time required for transfer.

Therefore, the information processing device 100 can prevent the buffer from being tight. Then, because the information processing device 100 can prevent the buffer from being tight, the information processing device 100 can prevent the counter value from being lost, and can prevent that it is difficult to accurately specify the temporal change in the counter value. Next, description of FIG. 10 will be made, and an example will be described in which the information processing device 100 sets a threshold.

In FIG. 10, it is assumed that the information processing device 100 set a threshold at the time t. The information processing device 100 acquires the measurement data dₜ at the time t. The information processing device 100 acquires accumulated difference value data Dₜ′ to be a reference. The accumulated difference value data Dₜ′ includes each type of an accumulated difference value at a time t′ that is equal to or more than the threshold at the previous time. The time t′ may also be different for each type. The information processing device 100 calculates the memory usage rate rₘₑₘ on the basis of the measurement data dₜ.

The information processing device 100 calculates threshold data Thₜ including a threshold corresponding to each type on the basis of the accumulated difference value data Dₜ′ and the memory usage rate rₘₑₘ. The threshold corresponding to each type is the corresponding type of the accumulated difference value included in the accumulated difference value data Dₜ′/the memory usage rate rₘₑₘ.

As a result, as the memory usage rate rₘₑₘ is larger, the threshold increases, and the information processing device 100 can easily overwrite the accumulated difference value with zero. Therefore, as the buffer is tighter, the information processing device 100 can further improve the compression efficiency and can make it difficult to reduce the empty size of the buffer. As a result, the information processing device 100 can prevent the counter value from being lost and can accurately specify the temporal change in the counter value.

(Specific Example of Operation of Information Processing System 200)

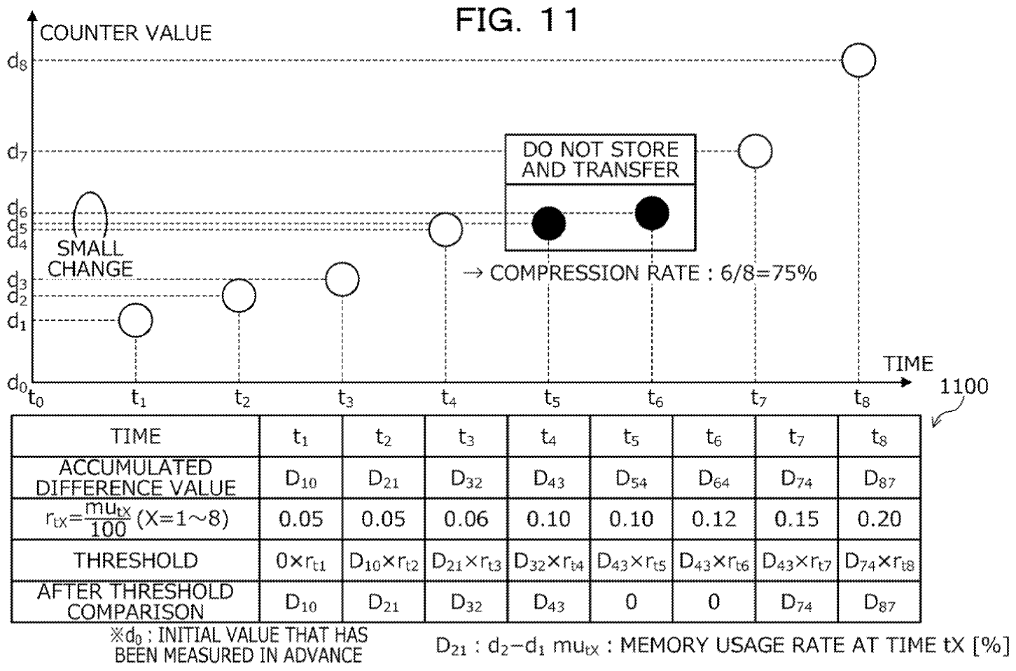

Next, a specific example of an operation of the information processing device 100 will be described with reference to FIGS. 11 to 16. In the following description, for simple description, a case will be described where the information processing device 100 measures only one type of the counter value and calculates only one type of the accumulated difference value.

FIGS. 11 to 16 are explanatory diagrams illustrating a specific example of the operation of the information processing system 200. The example in FIG. 11 corresponds to a case where a memory usage rate rₜₓ is relatively small. In FIG. 11, as illustrated in Table 1100, it is assumed that the information processing device 100 set a threshold at each of times t₁ to t₈, determine whether or not an accumulated difference value is equal to or more than the threshold, and overwrite the accumulated difference value that is less than the threshold with zero.

Here, because the memory usage rate rₜₓ is relatively small, the information processing device 100 sets a relatively small value as the threshold. Therefore, in the example in FIG. 11, the information processing device 100 overwrites the accumulated difference value D₅₄ at the time t₅ and the accumulated difference value D₅₄ at the time t₆ with zero.

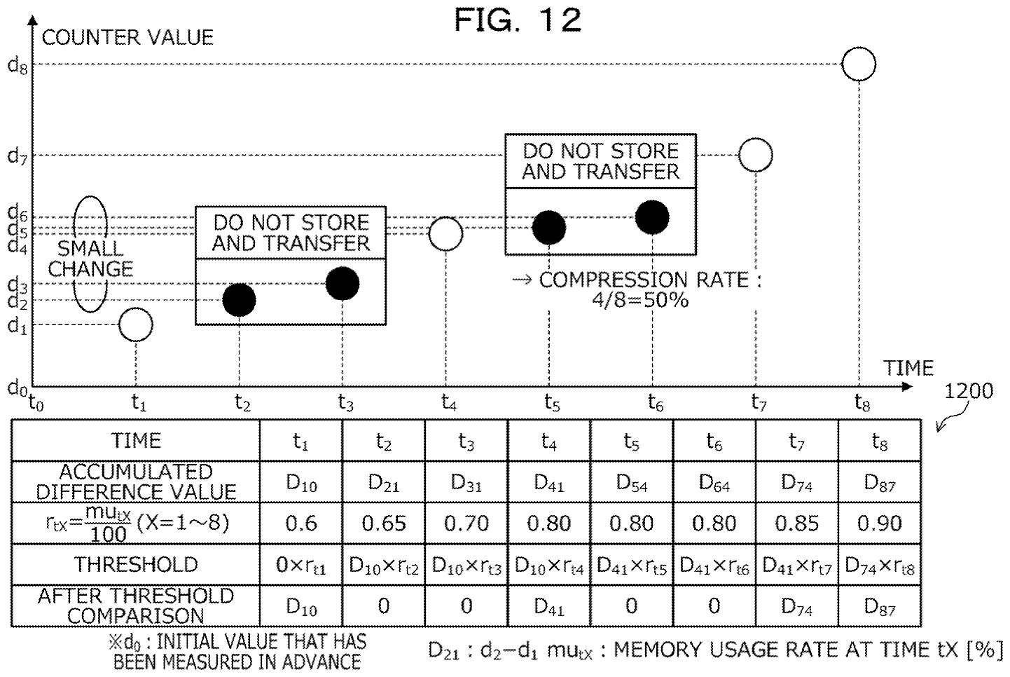

Therefore, the information processing device 100 can reduce a compression rate to 6/8, can reduce a transfer amount to 6/8, and can reduce a time required for transfer. Furthermore, the information processing device 100 can make it difficult for the buffer to be tight. Furthermore, if the memory usage rate rₜₓ is relatively small, the information processing device 100 can make it difficult to overwrite the accumulated difference value with zero and can easily and accurately specify the temporal change in the counter value in the storage destination. Next, the description proceeds to FIG. 12.

The example in FIG. 12 corresponds to a case where the memory usage rate rₜₓ is relatively large. In FIG. 12, as illustrated in Table 1200, it is assumed that the information processing device 100 set a threshold at each of times t₁ to t₈, determine whether or not an accumulated difference value is equal to or more than the threshold, and overwrite the accumulated difference value that is less than the threshold with zero.

Here, because the memory usage rate rₜₓ is relatively large, the information processing device 100 sets a relatively large value as the threshold. Therefore, in the example in FIG. 12, the information processing device 100 overwrites the accumulated difference value D₂₁ at the time t₂, the accumulated difference value D₃₁ at the time t₃, the accumulated difference value D₅₄ at the time t₅, and the accumulated difference value D₆₄ at the time t₆ with zero.

Therefore, the information processing device 100 can reduce a compression rate to 4/8, can reduce a transfer amount to 4/8, and can reduce a time required for transfer. Furthermore, the information processing device 100 can make it difficult for the buffer to be tight. In comparison with the example in FIG. 11, as the memory usage rate rₜₓ is larger, the information processing device 100 can more easily reduce the transfer amount.

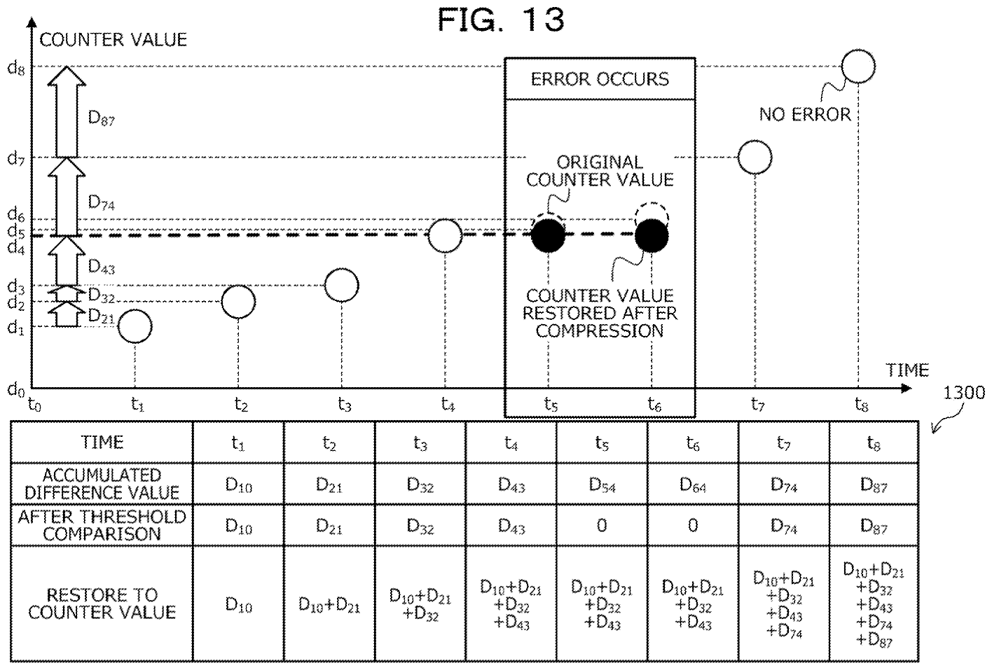

In this way, according to the memory usage rate rₜₓ, the information processing device 100 can appropriately improve the compression efficiency and can make it difficult to reduce the empty size of the buffer. As a result, the information processing device 100 can prevent the counter value from being lost and can accurately specify the temporal change in the counter value. Next, the description proceeds to FIG. 13.

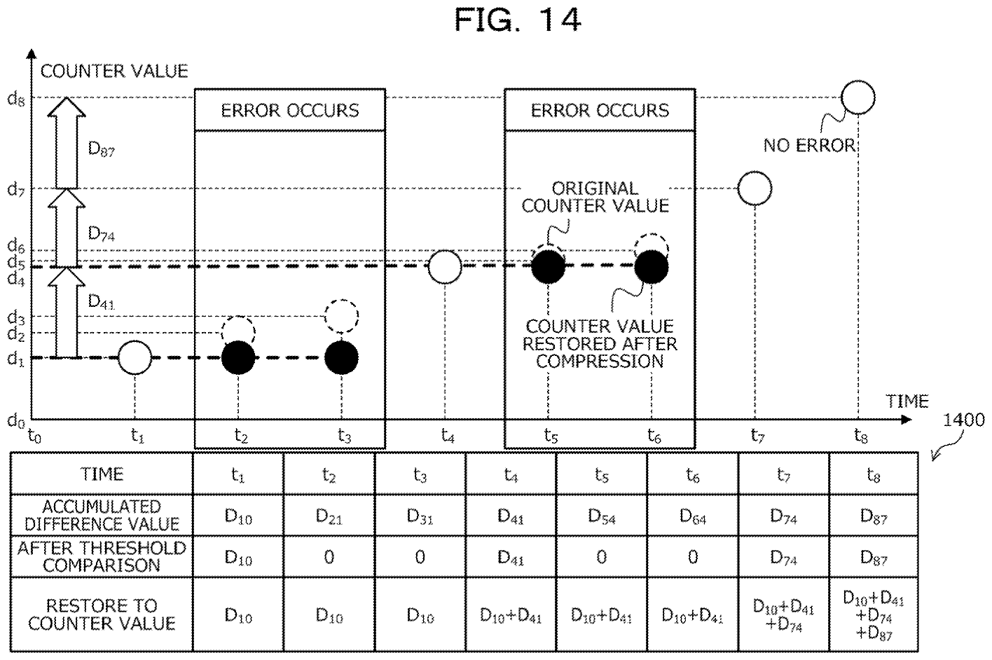

As in the example in FIG. 11, the example in FIG. 13 corresponds to a case where the memory usage rate rₜₓ is relatively small and indicates a case where the information management device 201 restores a counter value. As illustrated in Table 1300, the information management device 201 restores a counter value at each time by sequentially adding accumulated difference values. Here, the accumulated difference values D₅₄ and D₆₄ are overwritten with zero. Therefore, counter values d₅ and d₆ to be restored include an error. Next, the description proceeds to FIG. 14.

As in the example in FIG. 12, the example in FIG. 14 corresponds to a case where the memory usage rate rₜₓ is relatively large and indicates a case where the information management device 201 restores a counter value. As illustrated in Table 1400, the information management device 201 restores a counter value at each time by sequentially adding accumulated difference values. Here, the accumulated difference values D₂₁, D₃₁, D₅₄, and D₅₄ are overwritten with zero. Therefore, counter values d₂, d₃, d₅, and d₆ to be restored include an error.

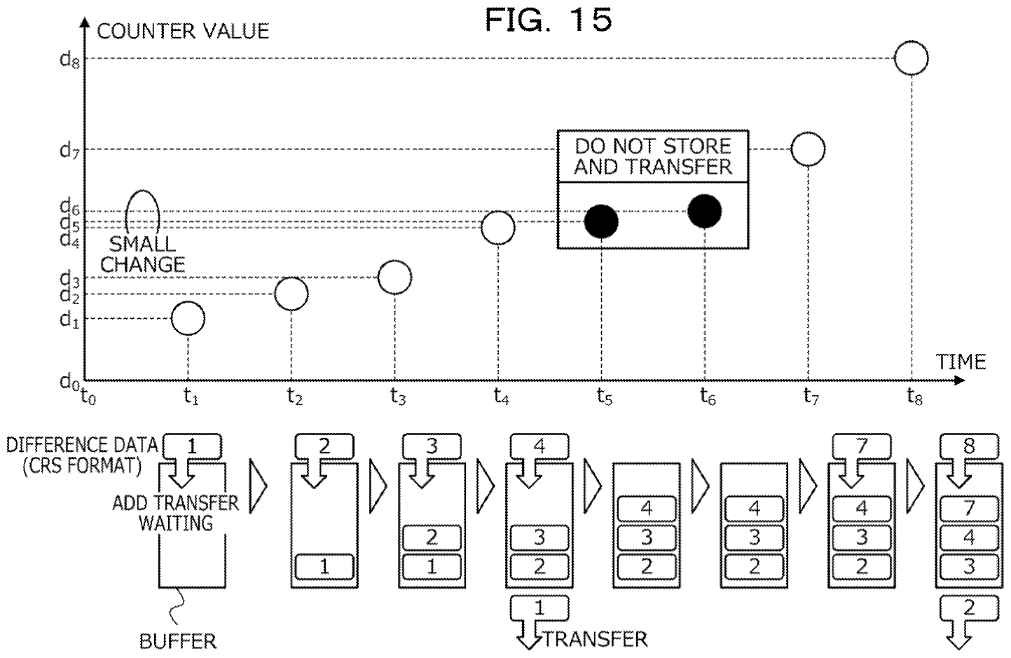

In this way, as the threshold increases, an error easily occurs. On the other hand, if the threshold is variable and the memory usage rate rₜₓ is relatively small, the information processing device 100 can set a threshold to be relatively small. Therefore, while preventing the buffer from being tight, the information processing device 100 can reduce a probability that an error occurs in the storage destination. Next, the description proceeds to FIG. 15.

As in the example in FIG. 11, the example in FIG. 15 corresponds to a case where the memory usage rate rₜₓ is relatively small and indicates a buffer empty state. As illustrated in Table 1100, it is assumed that the information management device 201 set the threshold at each of the times t₁ to t₈, determine whether or not the accumulated difference value is equal to or more than the threshold, and overwrite the accumulated difference value that is less than the threshold with zero.

The information processing device 100 accumulates the accumulated difference values calculated at each of the times t₁ to t₈ in a buffer. For example, in a case where the calculated accumulated difference value is overwritten with zero, the information processing device 100 does not need to accumulate the corresponding accumulated difference value in the buffer. In the example in FIG. 15, the information processing device 100 does not accumulate the accumulated difference value D₅₄ in the buffer at the time t₅. The information processing device 100 does not accumulate the accumulated difference value D₅₄ in the buffer at the time t₆.

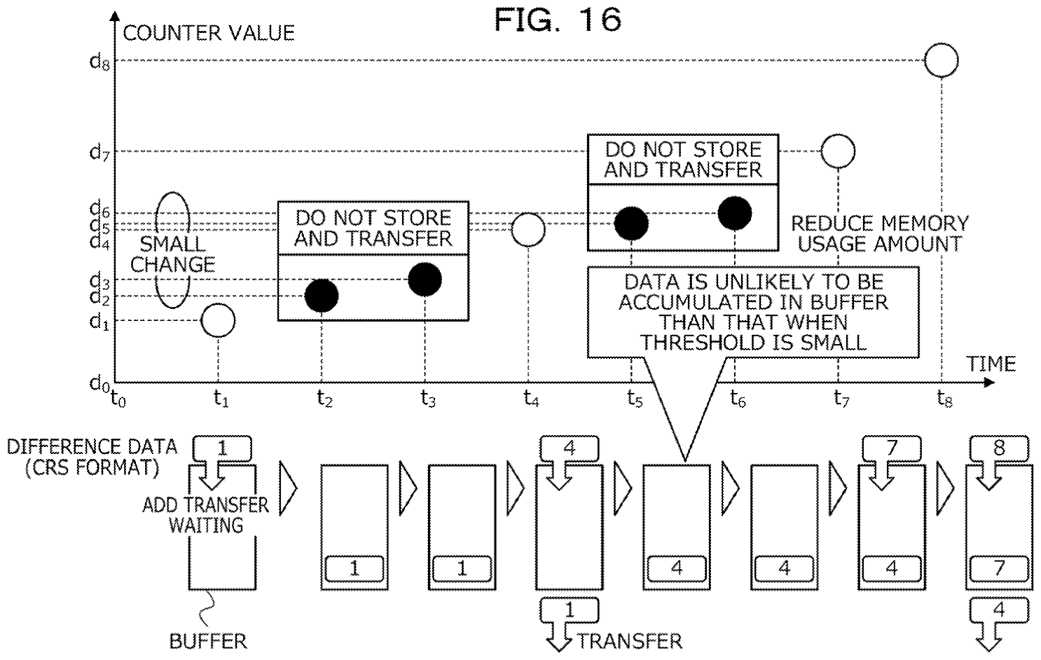

The information processing device 100 deletes the transferred accumulated difference value from the buffer in response to the transfer of the accumulated difference value to the storage destination. In the example in FIG. 15, if the accumulated difference value D₁₀ is transferred at the time t₄, the information processing device 100 deletes the transferred accumulated difference value D₁₀ from the buffer. Furthermore, if the accumulated difference value D₂₁ is transferred at the time t₈, the information processing device 100 deletes the transferred accumulated difference value D₂₁ from the buffer. In this way, the information processing device 100 can make it difficult for the buffer to be tight. Next, the description proceeds to FIG. 16.

As in the example in FIG. 12, the example in FIG. 16 corresponds to a case where the memory usage rate rₜₓ is relatively large and indicates a buffer empty state. As illustrated in Table 1200, it is assumed that the information management device 201 set the threshold at each of the times t₁ to t₈, determine whether or not the accumulated difference value is equal to or more than the threshold, and overwrite the accumulated difference value that is less than the threshold with zero.

The information processing device 100 accumulates the accumulated difference values calculated at each of the times t₁ to t₈ in a buffer. For example, in a case where the calculated accumulated difference value is overwritten with zero, the information processing device 100 does not need to accumulate the corresponding accumulated difference value in the buffer. In the example in FIG. 16, the information processing device 100 does not accumulate the accumulated difference value D₂₁ in the buffer at the time t₂. The information processing device 100 does not accumulate the accumulated difference value D₃₁ in the buffer at the time t₃. The information processing device 100 does not accumulate the accumulated difference value D₅₄ in the buffer at the time t₈. The information processing device 100 does not accumulate the accumulated difference value D₅₄ in the buffer at the time t₆.

The information processing device 100 deletes the transferred accumulated difference value from the buffer in response to the transfer of the accumulated difference value to the storage destination. In the example in FIG. 16, if the accumulated difference value D₁₀ is transferred at the time t₄, the information processing device 100 deletes the transferred accumulated difference value D₁₀ from the buffer. Furthermore, if the accumulated difference value D₂₁ is transferred at the time t₈, the information processing device 100 deletes the transferred accumulated difference value D₂₁ from the buffer. In this way, the information processing device 100 can make it difficult for the buffer to be tight. By setting the threshold to be relatively large, the information processing device 100 can easily increase the empty size of the buffer.

(Example of Effect of Information Processing Device 100)

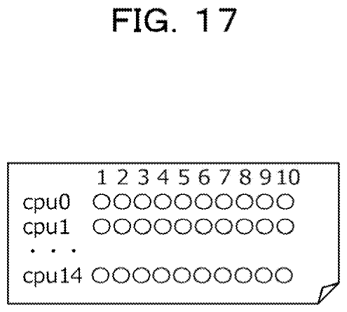

Next, an example of an effect of the information processing device 100 will be described with reference to FIGS. 17 to 19. In the following description, a case will be described where the information processing device 100 measures each of a plurality of types of counter values.

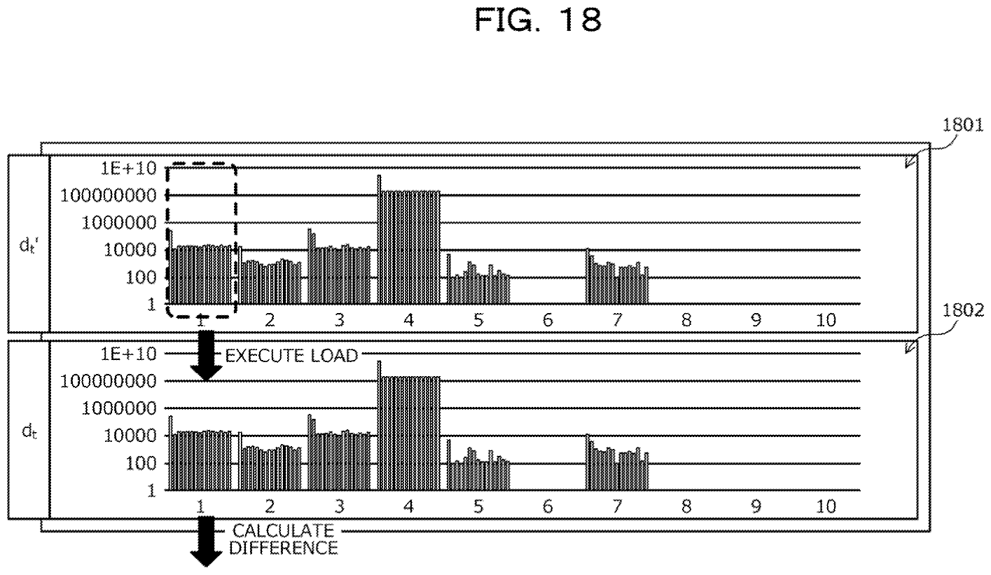

FIGS. 17 to 19 are explanatory diagrams illustrating an example of the effect of the information processing device 100. As illustrated in FIG. 17, it is assumed that the information processing device 100 measure a counter value regarding each of 10 attributes included in each of 15 CPUs 301. Therefore, it is assumed that the information processing device 100 measure 150 counter values. Next, the description proceeds to FIG. 18.

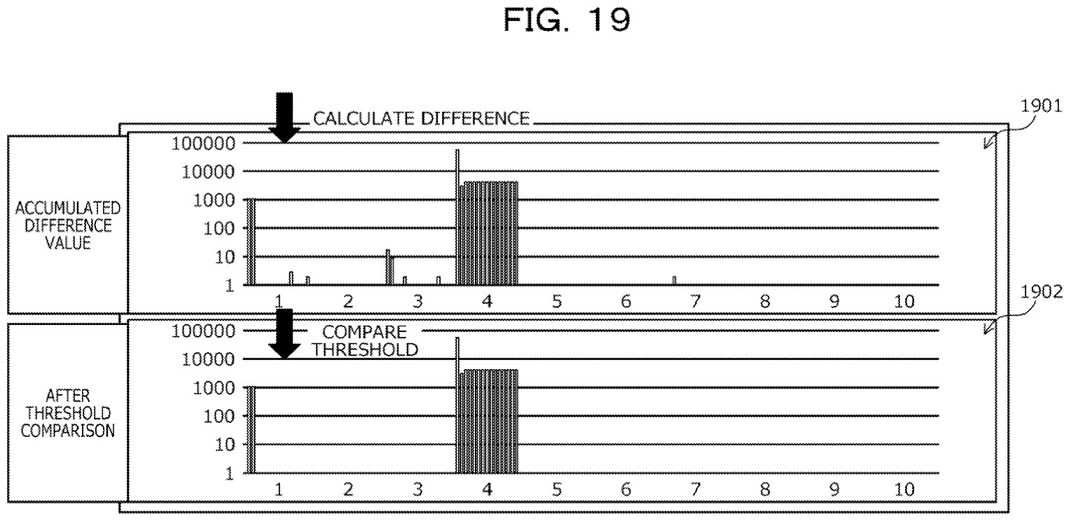

In FIG. 18, the information processing device 100 acquires measurement data dₜ′ at a time t′. The measurement data dₜ′ includes, for example, 150 counter values at the time t′ illustrated in a graph 1801. The time t′ may also be different, for example, for each counter value. The time t′ is, for example, a time in the past at which an accumulated difference value corresponding to a previous counter value is equal to or more than a threshold. The information processing device 100 acquires the measurement data dₜ at the time t. The measurement data dₜ includes, for example, 150 counter values at the time t illustrated in a graph 1802. Next, the description proceeds to FIG. 19.

In FIG. 19, the information processing device 100 generates the accumulated difference value data Dₜ=the measurement data dₜ′−the measurement data dₜ′. The accumulated difference value data Dₜ includes, for example, 150 accumulated difference values at the time t illustrated in a graph 1901. The information processing device 100 determines whether or not the 150 accumulated difference values included in the accumulated difference value data Dₜ are equal to or more than the threshold. The information processing device 100 overwrites the accumulated difference value in the accumulated difference value data Dₜ that is less than the threshold with zero. The overwritten accumulated difference value data Dₜ includes, for example, 150 accumulated difference values at the time t illustrated in a graph 1902.

In this way, as illustrated in the graphs 1901 and 1902, the information processing device 100 can reduce the number of non-zero included in the accumulated difference value data Dₜ and can improve the compression efficiency of the accumulated difference value data Dₜ. Therefore, the information processing device 100 can make it difficult for the buffer to be tight and can accurately specify the temporal change in the counter value in the storage destination.

(Transfer Processing Procedure)

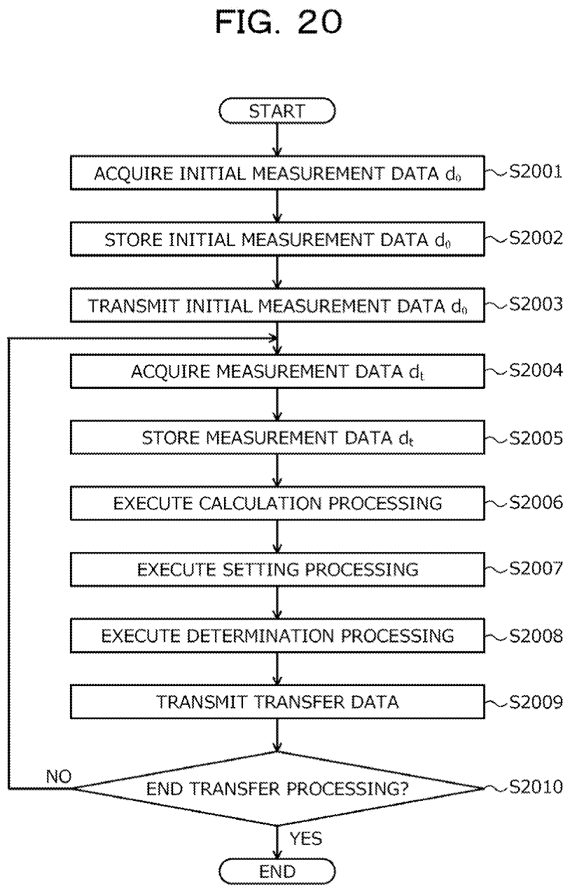

Next, an example of a transfer processing procedure executed by the information processing device 100 will be described with reference to FIG. 20. The transfer processing is implemented by, for example, the CPU 301, the storage region such as the memory 302 or the recording medium 305, and the network I/F 303 illustrated in FIG. 3.

FIG. 20 is a flowchart illustrating an example of the transfer processing procedure. In FIG. 20, the information processing device 100 acquires initial measurement data d₀ from the Kernel or the CPU 301 (step S2001). The measurement data d₀ includes, for example, each of a plurality of types of counter values.

Next, the information processing device 100 stores the initial measurement data d₀ in a memory (step S2002). Then, the information processing device 100 transmits the initial measurement data d₀ to the information management device 201 (step S2003).

Next, the information processing device 100 acquires the measurement data dₜ from the Kernel or the CPU 301 (step S2004). The measurement data dₜ includes, for example, each of a plurality of types of counter values. Then, the information processing device 100 stores the measurement data dₜ in the memory (step S2005).

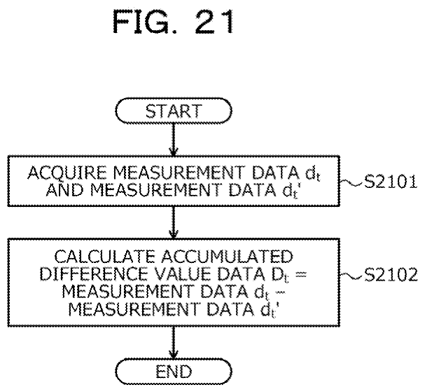

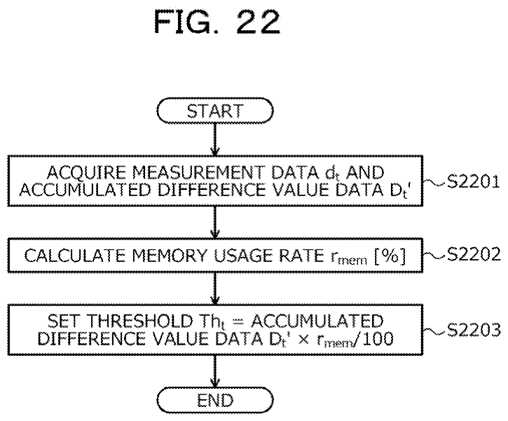

Next, the information processing device 100 generates the accumulated difference value data Dₜ by executing calculation processing described later with reference to FIG. 21 (step S2006). The accumulated difference value data Dₜ includes, for example, each of a plurality of types of accumulated difference values. Then, the information processing device 100 sets the threshold data Thₜ by executing setting processing described later with reference to FIG. 22 (step S2007). The threshold data Thₜ includes a threshold corresponding to each of the plurality of types.

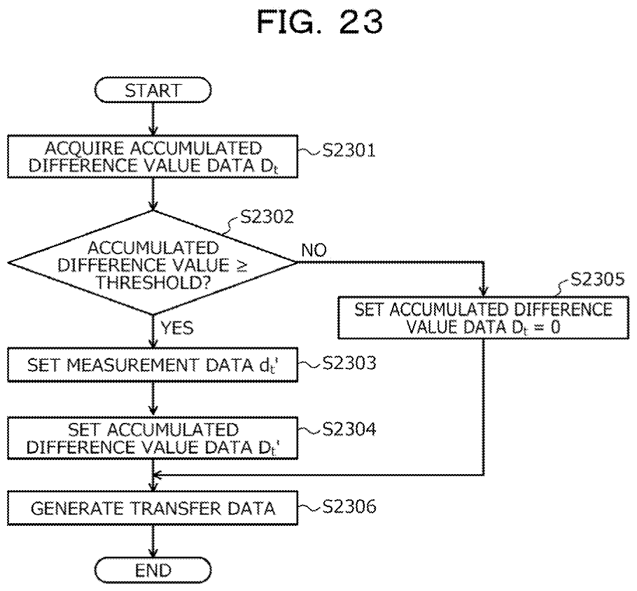

Next, the information processing device 100 generates the transfer data by executing determination processing described later with reference to FIG. 23 (step S2008). Then, the information processing device 100 transmits the generated transfer data to the information management device 201 (step S2009).

Next, the information processing device 100 determines whether or not to end the transfer processing (step S2010). Here, in a case where the transfer processing does not end (step S2010: No), the information processing device 100 returns to the processing in step S2004. On the other hand, in a case where the transfer processing ends (step S2010: Yes), the information processing device 100 ends the transfer processing.

In a case of ending the transfer processing, if there is untransferred accumulated difference value data Dₜ, the information processing device 100 may also transmit the data to the information management device 201. As a result, the information processing device 100 can enable the information management device 201 to accurately specify the temporal change in the counter value.

(Calculation Processing Procedure)

Next, an example of a calculation processing procedure executed by the information processing device 100 will be described with reference to FIG. 21. The calculation processing is implemented by, for example, the CPU 301, the storage region such as the memory 302 or the recording medium 305, and the network I/F 303 illustrated in FIG. 3.

FIG. 21 is a flowchart illustrating an example of the calculation processing procedure. In FIG. 21, the information processing device 100 acquires the measurement data dₜ and the measurement data dₜ′ from the memory (step S2101).

Next, the information processing device 100 calculates the accumulated difference value data Dₜ=the measurement data dₜ−the measurement data dₜ′ and stores the calculated result in the memory (step S2102). Then, the information processing device 100 ends the calculation processing. As a result, the information processing device 100 can obtain a guideline for determining whether or not each of the plurality of types is set as the transfer target.

(Setting Processing Procedure)

Next, an example of a setting processing procedure executed by the information processing device 100 will be described with reference to FIG. 22. The setting processing is implemented by, for example, the CPU 301, the storage region such as the memory 302 or the recording medium 305, and the network I/F 303 illustrated in FIG. 3.

FIG. 22 is a flowchart illustrating an example of the setting processing procedure. In FIG. 22, the information processing device 100 acquires the measurement data dₜ and the accumulated difference value data Dₜ′ from the memory (step S2201). The accumulated difference value data Dₜ′ includes the corresponding type of accumulated difference value that is equal to or more than the threshold at the previous time for each of the plurality of types.

Next, the information processing device 100 calculates the memory usage rate rₘₑₘ [%] on the basis of the measurement data dₜ (step S2202). The information processing device 100 calculates the memory usage rate rₘₑₘ [%] by increasing the memory usage rate rₘₑₘ [%] by a size of the measurement data dₜ.

Then, the information processing device 100 sets the threshold data Thₜ=the accumulated difference value data Dₜ′×rₘₑₘ/100 (step S2203). The threshold data Thₜ includes, for example, a threshold corresponding to each of the plurality of types. Thereafter, the information processing device 100 ends the setting processing. As a result, the information processing device 100 can set the threshold to be variable and can accurately determine whether or not each of the plurality of types is set as the transfer target.

(Determination Processing Procedure)

Next, an example of a determination processing procedure executed by the information processing device 100 will be described with reference to FIG. 23. The determination processing is implemented by, for example, the CPU 301, the storage region such as the memory 302 or the recording medium 305, and the network I/F 303 illustrated in FIG. 3.

FIG. 23 is a flowchart illustrating an example of the determination processing procedure. In FIG. 23, the information processing device 100 acquires the accumulated difference value data Dₜ from the memory (step S2301).

Next, the information processing device 100 determines whether or not the accumulated difference value the threshold is satisfied at least any one of the plurality of types on the basis of the accumulated difference value data Dₜ and the threshold data Thₜ (step S2302). Here, in a case where the accumulated difference value the threshold is not satisfied (step S2302: No), the information processing device 100 proceeds the procedure to the processing in step S2305. On the other hand, in a case where the accumulated difference value the threshold is satisfied (step S2302: Yes), the information processing device 100 proceeds the procedure to the processing in step S2303.

In step S2303, the information processing device 100 sets the measurement data dₜ′ (step S2303). For example, the information processing device 100 sets the measurement data dₜ′ by updating a type of a counter value included in the measurement data dₜ′ with the corresponding type of the counter value corresponding to the corresponding type of the accumulated difference value, which is equal to or more than a threshold, included in the measurement data dₜ.

Next, the information processing device 100 sets the accumulated difference value data Dₜ′ (step S2304). For example, the information processing device 100 sets the accumulated difference value data Dₜ′ by updating the corresponding type of the accumulated difference value included in the accumulated difference value data Dₜ′ with a type of an accumulated difference value, which is equal to or more than a threshold, included in the accumulated difference value data Dₜ. Then, the information processing device 100 proceeds the procedure to the processing in step S2306.

In step S2305, the information processing device 100 sets the accumulated difference value data Dₜ=0 (step S2305). For example, the information processing device 100 sets all the accumulated difference values included in the accumulated difference value data Dₜ to zero. Then, the information processing device 100 proceeds the procedure to the processing in step S2306.

In step S2306, the information processing device 100 generates the transfer data by applying the compression method for extracting a non-zero element to the accumulated difference value data Dₜ that has been accumulated (step S2306). Then, the information processing device 100 ends the determination processing. As a result, the information processing device 100 can generate the transfer data to be transferred to the information management device 201.

(Reception Processing Procedure)

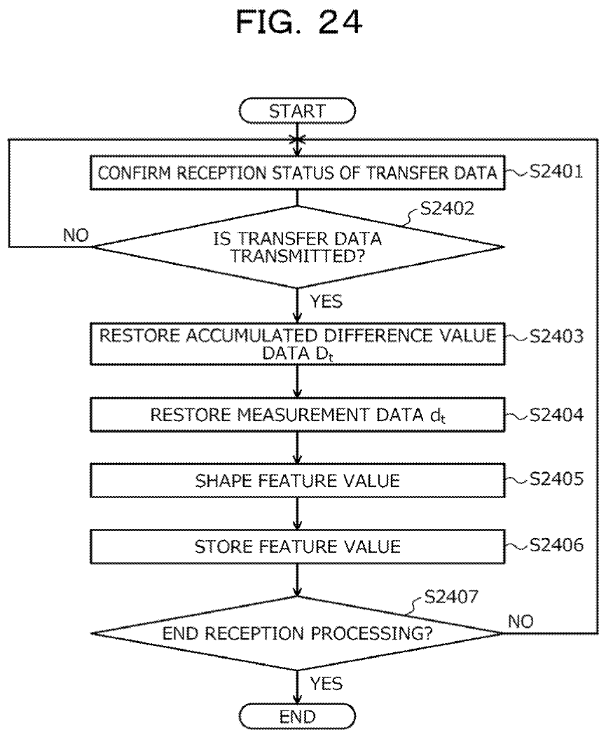

Next, an example of a reception processing procedure executed by the information management device 201 will be described with reference to FIG. 24. The reception processing is implemented by, for example, the CPU 301, the storage region such as the memory 302 or the recording medium 305, and the network I/F 303 illustrated in FIG. 3.

FIG. 24 is a flowchart illustrating an example of the reception processing procedure. In FIG. 24, the information management device 201 confirms a reception status of the transfer data through polling (step S2401).

Next, the information management device 201 determines whether or not the transfer data is transmitted from the information processing device 100 (step S2402). Here, in a case where the transfer data is not transmitted (step S2402: No), the information management device 201 returns to the processing in step S2401. On the other hand, in a case where the transfer data is transmitted (step S2402: Yes), the information management device 201 proceeds the procedure to the processing in step S2403.

In step S2403, the information management device 201 restores the accumulated difference value data Dₜ from the received transfer data (step S2403). Next, the information management device 201 restores the measurement data dₜ including the counter value that enables to calculate the feature value such as the CPU usage rate and the memory usage rate on the basis of the restored accumulated difference value data Dₜ (step S2404).

Next, the information management device 201 restores the feature value on the basis of the measurement data dₜ and shapes the restored feature value according to a format of the time series DB (step S2405). Then, the information management device 201 stores the shaped feature value in the time series DB (step S2406).

Next, the information management device 201 determines whether or not to end the reception processing (step S2407). Here, in a case where the reception processing does not end (step S2407: No), the information management device 201 returns to the processing in step S2401. On the other hand, in a case where the reception processing ends (step S2407: Yes), the information management device 201 ends the reception processing. As a result, the information management device 201 can specify the temporal change in the feature value.

As described above, according to the information processing device 100, at each predetermined time point, it is possible to measure the first type of the feature value regarding the corresponding time point. According to the information processing device 100, it is possible to calculate the accumulated difference value from the first feature value regarding the first time point to the second feature value regarding the second time point after the first time point, of the measured feature values. According to the information processing device 100, it is possible to determine whether or not the second feature value is set as the transfer target to be transferred to the storage destination on the basis of the result of comparing the calculated accumulated difference value with the threshold. As a result, the information processing device 100 can accurately specify the temporal change in the feature value in the storage destination.

According to the information processing device 100, in a case where the second feature value is determined as the transfer target, it is possible to transfer the calculated accumulated difference value to the storage destination. According to the information processing device 100, in a case where the second feature value is not set as the transfer target, it is possible to convert the calculated accumulated difference value into zero and transfer the accumulated difference value converted into zero to the storage destination. As a result, the information processing device 100 can reduce a data size, can reduce a time required for transfer, and can prevent the storage region where the feature value is accumulated from being tight.

According to the information processing device 100, it is possible to delete the feature value corresponding to the accumulated difference value that has been transferred to the storage destination from the storage region where the measured feature value is accumulated. As a result, the information processing device 100 can prevent the storage region where the feature value is accumulated from being tight.

According to the information processing device 100, at each predetermined time point, it is possible to measure each of the plurality of types of the feature values regarding the corresponding time point. According to the information processing device 100, for each type, it is possible to calculate the accumulated difference value from the corresponding type of the first feature value regarding the first time point to the corresponding type of the second feature value regarding the second time point, of the corresponding types of the measured feature values. According to the information processing device 100, for each type, it is possible to determine whether or not the corresponding type of the second feature value is determined as the transfer target on the basis of the result of comparing the calculated accumulated difference value with the threshold. As a result, the information processing device 100 can be applied to a case where each of the plurality of types of the feature values exists.

According to the information processing device 100, it is possible to convert a first accumulated difference value corresponding to the second type of the second feature value determined not to be set as the transfer target, among the calculated accumulated difference values, into zero. According to the information processing device 100, it is possible to transfer the first accumulated difference value that has been converted into zero and a second accumulated difference value corresponding to a third type of the second feature value determined as the transfer target of the calculated accumulated difference values to the storage destination. As a result, the information processing device 100 can reduce a data size, can reduce a time required for transfer, and can prevent the storage region where the feature value is accumulated from being tight.

According to the information processing device 100, it is possible to apply the compression method for extracting non-zero to the accumulated difference data including the first accumulated difference value that has been converted into zero and the second accumulated difference value and to transfer the compressed accumulated difference data to the storage destination. As a result, the information processing device 100 can reduce a data size, can reduce a time required for transfer, and can prevent the storage region where the feature value is accumulated from being tight.

According to the information processing device 100, it is possible to determine whether or not the corresponding type of the second feature value is determined as the transfer target on the basis of the result of comparing the accumulated difference value calculated for each type with the threshold corresponding to the corresponding type. As a result, the information processing device 100 can use a different threshold for each type and can accurately determine whether or not the corresponding type of the second feature value is set as the transfer target.

According to the information processing device 100, it is possible to acquire the accumulated difference value from the fourth feature value regarding the fourth time point before the third time point that is used when the third feature value regarding the third time point before the first time point is determined as the transfer target to the third feature value, of the measured feature values. According to the information processing device 100, it is possible to set the threshold on the basis of the acquired accumulated difference value and the empty state of the storage region where the measured feature value is accumulated. As a result, the information processing device 100 can set an appropriate threshold.

According to the information processing device 100, it is possible to determine the feature value that has been measured first as the transfer target. As a result, the information processing device 100 can specify the feature value to be the reference in the storage destination.

According to the information processing device 100, in a case where the second feature value is determined as the transfer target, the second feature value can be transferred to the storage destination, and in a case where it is determined that the second feature value is not set as the transfer target, the second feature value can be discarded without transferring the second feature value to the storage destination. As a result, the information processing device 100 can prevent the storage region where the feature value is accumulated from being tight.

According to the information processing device 100, in a case where the calculated accumulated difference value is equal to or more than the threshold, the second feature value can be determined as the transfer target, and in a case where the calculated accumulated difference value is less than the threshold, it is possible to determine that the second feature value is not set as the transfer target. As a result, the information processing device 100 can appropriately determine whether or not the second feature value is set as the transfer target.

According to the information processing device 100, it is possible to adopt a device different from the information processing device 100 as the storage destination. As a result, the information processing device 100 can implement a system in collaboration with the device different from the information processing device 100.

Note that the information processing method described in the present embodiment may be implemented by executing a program prepared in advance, on a computer such as a PC or a workstation. The information processing program described in the present embodiment is executed by being recorded on a computer-readable recording medium and being read from the recording medium by the computer. The recording medium is a hard disk, a flexible disk, a compact disc (CD)-ROM, a magneto-optical disc (MO), a digital versatile disc (DVD), or the like.

Furthermore, the information processing program described in the present embodiment may also be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute processing comprising:
at each predetermined time point, measuring a first type of a feature value regarding the corresponding time point;
calculating an accumulated difference value from a first feature value regarding a first time point to a second feature value regarding a second time point after the first time point, among the measured feature values; and
determining whether or not the second feature value is set as a transfer target to be transferred to a storage destination on the basis of a result of comparing the calculated accumulated difference value with a threshold.

2. The non-transitory computer-readable recording medium storing the information processing program according to claim 1, for causing the computer to execute processing comprising:
transferring the calculated accumulated difference value to the storage destination in a case where the second feature value is determined as the transfer target and converting the calculated accumulated difference value into zero and transferring the accumulated difference value that has been converted into zero to the storage destination in a case where the second feature value is not determined as the transfer target.

3. The non-transitory computer-readable recording medium storing the information processing program according to claim 2, for causing the computer to execute processing comprising:
deleting the feature value that corresponds to the accumulated difference value that has been transferred to the storage destination from a storage region where the measured feature value is accumulated.

4. The non-transitory computer-readable recording medium storing the information processing program according to claim 1, for causing the computer to execute processing, wherein
the measuring processing,
at each predetermined time point, measures each of a plurality of types of feature values regarding the corresponding time point,
the calculating processing
calculates an accumulated difference value from the corresponding type of the first feature value regarding the first time point to the corresponding type of the second feature value regarding the second time point among the corresponding types of measured feature values for each of the corresponding types, and
determining processing
determines whether or not the corresponding type of the second feature value is set as the transfer target on the basis of a result of comparing the calculated accumulated difference value with the threshold, for each type.

5. The non-transitory computer-readable recording medium storing the information processing program according to claim 4, for causing the computer to execute processing comprising:
converting a first accumulated difference value that corresponds to a second type of the second feature value determined not to be set as the transfer target among the calculated accumulated difference value into zero and transferring the first accumulated difference value that has been converted into zero and a second accumulated difference value that corresponds to a third type of the second feature value determined as the transfer target among the calculated accumulated difference value to the storage destination.

6. The non-transitory computer-readable recording medium storing the information processing program according to claim 5, wherein
the transferring processing
applies a compression method for extracting non-zero to accumulated difference data that includes the first accumulated difference value that has been converted into zero and the second accumulated difference value and transfers the compressed accumulated difference data to the storage destination.

7. The non-transitory computer-readable recording medium storing the information processing program according to claim 4, wherein
the determining processing
determines whether or not the corresponding type of the second feature value is set as the transfer target on the basis of a result of comparing the accumulated difference value calculated for each type and the threshold that corresponds to the corresponding type.

8. The non-transitory computer-readable recording medium storing the information processing program according to claim 1, for causing the computer to execute processing comprising:
setting the threshold on the basis of an accumulated difference value from a fourth feature value regarding a fourth time point before a third time point that is used when a third feature value regarding the third time point before the first time point is determined as the transfer target to the third feature value among the measured feature values and an empty state of a storage region where the measured feature value is accumulated.

9. The non-transitory computer-readable recording medium storing the information processing program according to claim 1, for causing the computer to execute processing comprising:
determining the feature value that has been measured first as the transfer target.

10. The non-transitory computer-readable recording medium storing the information processing program according to claim 1, for causing the computer to execute processing comprising:
transferring the second feature value to the storage destination in a case where the second feature value is determined as the transfer target and discarding the second feature value without transferring the second feature value to the storage destination in a case where the second feature value is not determined as the transfer target.

11. The non-transitory computer-readable recording medium storing the information processing program according to claim 1, wherein
the determining processing
determines the second feature value as the transfer target in a case where the calculated accumulated difference value is equal to or more than the threshold and determines that the second feature value is not set as the transfer target in a case where the calculated accumulated difference value is less than the threshold.

12. The non-transitory computer-readable recording medium storing the information processing program according to any claim 1, wherein
the storage destination is a device different from the computer.

13. An information processing method comprising:
at each predetermined time point, measuring, by a computer, a first type of a feature value regarding the corresponding time point;
calculating an accumulated difference value from a first feature value regarding a first time point to a second feature value regarding a second time point after the first time point, among the measured feature values; and
determining whether or not the second feature value is set as a transfer target to be transferred to a storage destination on the basis of a result of comparing the calculated accumulated difference value with a threshold.

14. An information processing device comprising:
a memory; and
a processor coupled to the memory and configured to:
at each predetermined time point, measure a first type of a feature value regarding the corresponding time point;
calculate an accumulated difference value from a first feature value regarding a first time point to a second feature value regarding a second time point after the first time point, among the measured feature values; and
determine whether or not the second feature value is set as a transfer target to be transferred to a storage destination on the basis of a result of comparing the calculated accumulated difference value with a threshold.
